(19) United States
(12) Patent Application Publication
(10) Pub. No.: US 2026/0369703 A1
(43) Pub. Date: Nov. 19, 2026

(54) Flame Retarding Electrolyte For Lithium Ion Energy Storage Device

(71) Applicant: Nanotech Energy, Inc., Sunny Isles Beach, FL (US)

(72) Inventors: Young Sam Park, Sunny Isles Beach, FL (US); Margaret Fairamitani, Sunny Isles Beach, FL (US); Patrick Quinn, Sunny Isles Beach, FL (US); Maher El-Kady, Los Angeles, CA (US)

(21) Appl. No.: 19/730,175

(22) Filed: Jul. 2, 2026

Related U.S. Application Data
(63) Continuation of application No. PCT/US2025/010319, filed on Jan. 3, 2025.
(60) Provisional application No. 63/618,176, filed on Jan. 5, 2024.

(51) Int. Cl. H01M 10/42; H01M 10/0525; H01M 10/0567; H01M 10/0568; H01M 10/0569

(52) U.S. Cl. CPC H01M 10/4235; H01M 10/0567; H01M 10/0568; H01M 10/0569; H01M 10/0525

(57) ABSTRACT

In an aspect of the present disclosure is a non-flammable electrolyte formulation comprising one or more non-aqueous organic solvents, a cathode additive, one or more anode additives, and one or more lithium salts, a non-flammable material comprising phosphazene, where the formulation is self-extinguishing or does not combust when exposed to flame, and does not exhibit reduced electrochemical performance due to the non-flammable properties of the electrolyte.

### CROSS REFERENCE

This application is a continuation of PCT/US2025/010319, filed on 2025 Jan. 3, which claims the benefit of U.S. Provisional Patent Application No. 63/618,176, filed on 2024 Jan. 5, both of which are incorporated herein by reference in their entirety.

### BACKGROUND

Lithium ion energy storage devices with NCM chemistry are often utilized in industry for various applications requiring high energy density cells. However, a number of such energy storage devices commonly suffer from rapid degradation, poor electrical chemical performance under extended use in high temperature conditions, and present significant safety risks.

### SUMMARY

Lithium ion batteries have the remarkable advantages of high working voltage, high energy density, and the like. However, the safety of the lithium ion batteries has attracted persistent attention since it is a main technical problem restricting further lithium ion battery application. In particular, the electrolyte is one of four major battery materials and always consists of highly flammable liquid organics, which are easy to ignite and release a lot of heat. Commercial electrolytes comprising mainly carbonates such as EC, DMC, DEC and EMC all show low boiling and flash points, which may cause bulging in injected batteries and post a serious safety risk. Therefore, electrolytes with higher safety performance must be developed to improve the safety of the lithium ion battery. It is critical to solve the technical problem of flammability of the electrolyte on the premise of not affecting the electrochemical performance of the lithium ion battery. However, it is critical to solve the technical problem of flammability of the of the electrolyte without negatively effecting the electrochemical performance of the lithium ion battery electrolyte in order for such changes to be widely adopted.

Aspects disclosed here and provide nonflammable electrolyte formulations which significantly increased the safety and operating temperatures of lithium ion based energy storage devices, without negatively impacting electrochemical performance, thereby addressing the technical problem of highly flammable electrolyte formulations, and nonflammable electrolyte formulations with poor electrochemical performance. Surprisingly and unexpectedly, it is observed the formulations of the present disclosure comprising highly flammable components can be adapted to a nonflammable electrolyte formulation with a high degree of electrochemical performance with the addition of a nonflammable additive(s) to the formulation, in combination with one or more anode or cathode additives. The formulations of the present disclosure provide a solution to the technical problem of nonflammable electrolyte formulations with poor electrochemical performance and/or highly flammable electrolytes that present safety risks with the non-flammable electrolyte formulation comprising a nonflammable additive(s) to the formulation, in combination with one or more anode or cathode additives. In some embodiments, the non-flammable component of the formulation may comprise not have a flashpoint. In some cases, blending commercial carbonate electrolytes with the high flash point or no flash point component may render the overall formulation nonflammable, without negatively impacting electrochemical performance. In some cases, the high flash point or no flash point component may be a flame retardant component. In some cases, the flame retardant component may provide a self-extinguishing path with other flammable reagents the cell. In some cases, the flame retardant component when combined with other additives of the formulation may provide a complex comprising a self-extinguishing core structure, with secondary organic functional groups surrounding self-extinguishing core, and producing an electrolyte formulation and resulting electrochemical cell having high oxidative durability at high voltages. The self-extinguishing core may comprise a plurality of free radicals to scavenge hydrogen and hydroxide radicals formed by thermal decomposition of carbonate solvents, thereby providing for a self-extinguishing material in the context of an electrolyte formulation comprising the flame retardant component and other flammable organic carbonate solvents. In some cases, the flame retardant compound is a phosphorus compound, for example, a phosphazene compound. In some cases, the phosphazene compound is Ethoxy(pentafluoro)cyclotriphosphazene. In some cases, the electrochemical performance of the non-flammable electrolyte formulation is maintained by a combination of one or more cathode additives, one or more anode additives, and a binary system of lithium salts. In some cases, the electrochemical performance of the nonflammable electrolyte formulation is maintained by a primary cathode additive, an anode additive, a secondary, tertiary, and or a quaternary anode additive, and a binary or ternary system of lithium salts. In some embodiments, lithium ion energy storage devices comprising the nonflammable electrolyte formulation do not undergo degradation as to produce gaseous byproducts which increase on intracellular pressure of the energy storage device, thereby preventing an increase in temperature and or pressure within the energy storage device, and improving the safety and thermal operating window of the energy storage device. In some embodiments, energy storage devices utilizing the non-flammable electrolyte formulation of the present disclosure provides a similar or equivalent level of electrochemical performance as commercially available electrolytes that are flammable. And some embodiments, the nonflammable electrolyte formulations of the present disclosure provide for energy storage devices that maintain 80% or greater capacity retention at 1000 cycles. In some embodiments, the nonflammable electrolyte formulations of the present disclosure provide for energy storage devices that maintain 85% or greater capacity retention at 500 cycles. In some embodiments, the nonflammable electrolyte formulation of the present disclosure does not undergo thermal degradation when operated at 60 °C or higher for extended periods. And some embodiments, the nonflammable electrolyte formulation of the present disclosure is compatible with sulfur compounds, even at high temperatures. In some embodiments, the nonflammable electrolyte formulation of the present disclosure enhances the thermal stability of the nonflammable electrolyte formulation comprising a carbonate system comprising one or more sulfur compounds.

In an aspect of the present disclosure is a non-flammable electrolyte formulation comprising one or more non-aqueous organic solvents, a cathode additive, one or more anode additives, and one or more lithium salts, a non-flammable material comprising phosphazene in an amount of greater than 5% up to 25% w/w of the formulation, wherein the formulation is self-extinguishing or does not combust when exposed to flame.

In an aspect of the present disclosure is a non-flammable electrolyte formulation comprising one or more non-aqueous organic solvents, a cathode additive comprising a nitrile moiety, one or more anode additives, one or more lithium salts, and a non-flammable material comprising an amount of greater than 5% up to 25% w/w of the formulation.

In an aspect of the present disclosure is a non-flammable electrolyte formulation comprising one or more non-aqueous organic solvents, a cathode additive, one or more anode additives, one or more lithium salts, and a non-flammable material, wherein the electrolyte formulation is non-flammable when exposed to flame or does not undergo thermal decomposition when heated to a temperature of 60 °C for 12 days.

In an aspect of the present disclosure is a non-flammable electrolyte formulation comprising one or more non-aqueous organic solvents, a cathode additive, one or more anode additives, one or more lithium salts, and a non-flammable material, wherein the non-flammable electrolyte formulation does not exhibit produce a decrease in output voltage greater than 10% of an initial output voltage in a cell comprising the non-flammable electrolyte formulation when heated to a temperature of at least 60°.

In an aspect of the present disclosure is a non-flammable electrolyte formulation comprising one or more non-aqueous organic solvents, a cathode additive, one or more lithium salts, one or more anode additives comprising LiBOB, VC, and PS, wherein PS is the only sulfur compound in the formulation, and a non-flammable material.

In an aspect of the present disclosure is a non-flammable electrolyte formulation comprising one or more non-aqueous organic solvents, a cathode additive, one or more lithium salts, one or more anode additives, and a non-flammable material, wherein the one or more lithium salts and the one or more anode additives do not produce decomposition products at 60 °C up to 12 days.

In an aspect of the present disclosure is a non-flammable electrolyte formulation comprising one or more non-aqueous organic solvents, a cathode additive, a binary system of lithium salts comprising two of: Lithium Hexafluorophosphate, Lithium Tetrafluoroborate, Lithium Bis(fluorosulfonyl) Imide, or Lithium Bis(trifluoromethylsulfonyl) Imide, one or more anode additives, and a non-flammable material comprising phosphazene in an amount of greater than 5% up to 25% w/w of the formulation.

In an aspect of the present disclosure is use of a non-flammable electrolyte formulation in a method of preventing thermal runaway, comprising providing a formulation comprising one or more non-aqueous organic solvents comprising an alkyl carbonate, an ester organic solvent, or a fluoroether, a cathode additive, one or more anode additives, and a non-flammable material comprising phosphazene in an amount greater than 5% up to 25% w/w of the formulation, and operating an energy storage device comprising the formulation under conditions which heat the formulation, wherein the formulation is self-extinguishing or does not exhibit a decrease in output voltage greater than 10% of an initial output voltage in a cell comprising the electrolyte when heated to a temperature of at least 60 °C.

In some embodiments, the nonaqueous organic solvents comprise one or more of alkyl carbonates, an ester organic solvent, or a fluoroether. In some embodiments, the one or more non-aqueous organic solvents comprise ethylene carbonate, propylene carbonate, diethyl carbonate, dimethyl carbonate, ethyl methyl carbonate, gamma-butyrlactone, or FEP. In some embodiments, the formulation comprises at most four non-aqueous organic solvents. In some embodiments, the formulation comprises EC, DEC, and EMC. In some embodiments, the formulation comprises GBL and FEP. In some embodiments, the cathode additive comprises one or more of HTCN [1,3,6-Hexanetricarbonitrile], succinonitrile, or adiponitrile. In some embodiments, the formulation comprises about 0.5 wt % to about 5 wt % of the cathode additive by total electrolyte weight. In some embodiments, the formulation comprises at least about 0.5% wt % of the cathode additive by total electrolyte weight. In some embodiments, the formulation comprises up to about 5 wt % of the cathode additive by total electrolyte weight. In some embodiments, the one or more lithium salts comprise one or more of lithium hexafluorophosphate, lithium tetrafluoroborate, lithium bis(fluorosulfonyl)imide, or lithium bis(trifluoromethylsulfonyl)imide. In some embodiments, the one or more lithium salts is two lithium salts. In some embodiments, the one or more lithium salts are a binary system of lithium salts consisting of two of: Lithium Hexafluorophosphate, Lithium Tetrafluoroborate, Lithium Bis(fluorosulfonyl) Imide, or Lithium Bis(trifluoromethylsulfonyl) Imide. In some embodiments, the one or more lithium salts comprises LiPF₆ or LiBF₄. In some embodiments, the formulation comprises about 0.8 M to about 1.6M of each of the one or more lithium salts by concentration of the electrolyte. In some embodiments, the one or more anode additives comprise one or more of LiBOB (Lithium bis(oxalate)borate), Lithium difluoro(oxalate)borate, vinylene carbonate, or PS (1,3-Propane sultone). In some embodiments, the formulation comprises four anode additives. In some embodiments, the formulation comprises three anode additives. In some embodiments, the formulation comprises about 1 wt % to about 5 wt % of vinylene carbonate by total electrolyte weight. In some embodiments, the formulation comprises about 1 wt % to about 3 wt % of vinylene carbonate by total electrolyte weight. In some embodiments, the formulation comprises at least about 1.5 wt % of vinylene carbonate by total electrolyte weight. In some embodiments, the formulation comprises about 1 wt % to about 5 wt % of LiBOB by total electrolyte weight. In some embodiments, the formulation comprises at least about 1 wt % of LiBOB by total electrolyte weight. In some embodiments, the formulation comprises about 1 wt % to about 5 wt % of 1,3-Propane sultone by total electrolyte weight. In some embodiments, the formulation comprises about 1 wt % to about 3 wt % of 1,3-Propane sultone by total electrolyte weight. In some embodiments, the formulation comprises at least about 0.5 wt % of 1,3-Propane sultone by total electrolyte weight. In some embodiments, the nonflammable material is ethoxy(pentafluoro)cyclotriphosphazene. In some embodiments, the formulation comprises about 4 wt % to about 30 wt % of the nonflammable material by total electrolyte weight. In some embodiments, the formulation comprises about 4 wt % to about 10 wt % of the nonflammable material by total electrolyte weight. In some embodiments, the formulation comprises about 4 wt % to about 5 wt % of the nonflammable material by total electrolyte weight. In some embodiments, the formulation comprises at least about 5 wt % of the nonflammable material by total electrolyte weight. In some embodiments, the nonflammable material scavenges H and OH radicals. In some embodiments, an energy storage device comprising the formulation maintains at least 87% capacity retention at 500 cycles at 4.3V. In some embodiments, an energy storage device comprising the formulation maintains at least 80% capacity retention at 1000 cycles at 4.3V. In some embodiments, the formulation is stable with sulfur compounds for at least 12 days at 60 °C. In some embodiments, the formulation does not produce gas products when heated to 60 °C. In some embodiments, the formulation does not produce gas products leading to cell bulging. In some embodiments, the lithium salt and nonflammable material interact to mitigate decomposition of the lithium salt. In some embodiments, the formulation remains clear and colorless for at least 12 days at 60 °C. In some embodiments, the formulation does not form LiPF₆ decomposition products for at least 12 days at 60 °C. In some embodiments, the formulation has an ionic conductivity of 5.8 mS/cm at room temperature. In some embodiments, the formulation does not ignite upon exposure to fire for at least 10 seconds.

In an aspect of the present disclosure is a lithium ion energy storage device comprising: a positive electrode including a nickel-cobalt-manganese positive electrode active material, an anode electrode, a separator interposed between the positive electrode and the negative electrode, and the nonflammable electrolyte formulation as disclosed herein.

In an aspect of the present disclosure is a lithium ion energy storage device comprising an anode electrode, a cathode electrode, and an electrolyte formulation comprising one or more non-aqueous organic solvents, a cathode additive, one or more anode additives, a binary lithium salt system, and a non-flammable material comprising ethoxy(pentafluoro)cyclotriphosphazene, wherein the energy storage device does not exhibit a decrease in output voltage greater than 10 of an initial output voltage when heated to a temperature of at least 60 °C.

In some embodiments, the energy storage device loses at most 10% capacity retention by 500 cycles at 4.3 V. In some embodiments, the energy storage device has a first cycle coulombic efficiency of at least 88%. In some embodiments, the energy storage device does not exhibit a decrease in output voltage greater than 10% of an initial output voltage when stored at a temperature of at least 60 °C for up to 10 weeks. In some embodiments, the energy storage device has a charge density of at least 5.0 Ah. In some embodiments, the energy storage device is a battery. In some embodiments, the energy storage device is a capacitor. In some embodiments, the positive electrode active material is Li(NaₐCo_{b}Mn_{c})O₂, wherein 0.6<a<0.95, 0.025<b<0.20, 0.025<c<0.20, and a+b+c=1 in lithium secondary battery. In some embodiments, the anode is natural graphite, artificial graphite, blend of natural and artificial graphite, or mesocarbon microbeads (MCMB). In some embodiments, the formulation does not increase resistance of overall battery cell. In some embodiments, the formulation does not increase resistance of overall battery cell when heated to 60 °C.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows ionic conductivity measurements of electrolyte formulations disclosed herein.

FIGS. 2A-2D show formation data of electrolyte formulations disclosed herein. FIG. 2A shows FCC. FIG. 2B shows FDC. FIG. 2C shows FCE. FIG. 2D shows capacity check.

FIG. 3 shows formation voltage profiles of electrolyte formulations disclosed herein.

FIGS. 4A-4B show discharge and charge data of electrolyte formulations disclosed herein at 3 Coulombs for 10 seconds at 50% state of charge. FIG. 4A shows discharge data. FIG. 4B shows charge data.

FIG. 5 shows a cycle life test for electrolyte formulations disclosed herein.

FIGS. 6A-6C show a visual test of thermal stability of electrolyte formulations disclosed herein upon storage at 60 °C. FIG. 6A shows day 0. FIG. 6B shows day 1 and day 12 of OL1, OL3, and OL17. FIG. 6C shows day 1 and day 12 of RD412, OL63, OL65, OL66, and OL68.

FIG. 7 shows high temperature storage test at 60 °C and 4.35 V of electrolyte formulations disclosed herein.

FIGS. 8A-8D shows gas formation data for electrolyte formulations disclosed herein. FIG. 8A shows gas formation for OL1. FIG. 8B shows gas formation for RD412. FIG. 8C shows gas formation for OL65. FIG. 8D shows gas formation for OL68.

### DETAILED DESCRIPTION

While lithium ion devices have remarkable advantages of high working voltage, high energy density, and the like. However, electrolytes used in such energy storage devices generally include highly flammable liquid organics, which are easy to ignite and present significant safety risks. Electrolytes with higher safety performance must be developed to improve the safety of the lithium ion battery, however, it is critical to solve the technical problem of flammability of the electrolyte without negatively effecting the electrochemical performance of the lithium ion battery electrolyte in order for such changes to be widely adopted.

One major shortcoming of alkali metal-ion batteries is the flammability of currently used organic liquid electrolytes. These batteries are subject to catastrophic ‘thermal runaway’ events if they experience a deviation from their metastable state. Such an event could be caused, for example, by a short circuit, mechanical abuse, or overcharging, and lead to thermal ignition of the carbonate-based electrolyte. Also, layered oxides cathode materials, can contribute significantly to the onset of thermal runaway. The oxygen and heat released due to phase transformations of the layered oxides can cause further reactions with the electrolyte and the anode, leading to tremendous heat generation and thereby increasing the risk of fire in the battery. Overall, battery safety is a complex issue, but one of the key factors on the road towards safe battery cells is to design non-flammable electrolytes.

The need for a non-flammable electrolyte is a well known problem in lithium ion energy storage devices. There are significant safety issues including the flammability of cathodes, anodes, and organic electrolytes. However, the addition of non-flammable additives can increase viscosity, increase resistance of overall battery cell, and increase build up of materials on electrolytes.

The phosphorus compound, Ethoxy(pentafluoro)cyclotriphosphazene is nonflammable with no flash points. Blending commercial carbonates electrolyte with about 4% of the phosphazene compound by electrolyte total weight render the formulation flame-retarding and adding about 5% of the phosphazene to electrolyte convert the flammable electrolyte to completely nonflammable formulation. Mixture of this nonflammable phosphazene and commercial electrolyte maintain nearly equivalent ionic conductivity and viscosity of the formulation. This means there is no trade-off of cell performance by use of this nonflammable material. In fact, the phosphazene improves thermal stability of electrolyte, thus leading to improvement of cell performance at elevated temperatures. A well-tailored electrolyte formulation taking into consideration the overall battery chemistry in addition to the phosphazene is an important aspect to creating a truly nonflammable battery electrolyte.

Common carbonate-based solvents will produce hydrogen radicals upon heating, which will further react with oxygen to produce oxygen free radicals. This triggers the generation of more free radicals, eventually leading to a self-sustaining fire. An effective way of terminating this radical formation chain is by introducing hydrogen or oxygen radical scavengers, such as phosphorus-containing materials. The phosphorus radicals, part of the electrolyte decomposition products, can react with hydrogen radicals and inhibit the radical linear chain reaction, which suppresses the combustion of the electrolyte solvent. However, flame retardants can still burn if their flame quenching properties are overloaded. Thus, in order to completely remove flammability from electrolytes, the solvents must be completely incombustible and therefore the entire battery chemistry must be taken into account.

Aspects disclosed here and provide nonflammable electrolyte formulations which significantly increased the safety and operating temperatures of lithium ion based energy storage devices, without negatively impacting electrochemical performance, thereby addressing the technical problem of highly flammable electrolyte formulations, and nonflammable electrolyte formulations with poor electrochemical performance. Surprisingly and unexpectedly, it is observed the formulations of the present disclosure comparing highly flammable components, can be adapted to a nonflammable electrolyte formulation with a high degree of electrochemical performance with the addition of a nonflammable additive(s) to the formulation, in combination with one or more anode or cathode additives. In some embodiments, the non-flammable component of the formulation may comprise not have a flashpoint. In some cases, blending commercial carbonate electrolytes with the high flash point or no flash point component may render the overall formulation nonflammable, without negatively impacting electrochemical performance. In some cases, the high flash point or no flash point component may be a flame retardant component. In some cases, the flame retardant component may provide a self-extinguishing path with other flammable reagents the cell. In some cases, the flame retardant component when combined with other additives of the formulation may provide a complex comprising a self-extinguishing core structure, with secondary organic functional groups surrounding self-extinguishing core, and producing an electrolyte formulation and resulting electrochemical cell having high oxidative durability at high voltages. The self-extinguishing core may comprise a plurality of free radicals to scavenge hydrogen and hydroxide radicals formed by thermal decomposition of carbonate solvents, thereby providing for a self-extinguishing material in the context of an electrolyte formulation comprising the flame retardant component and other flammable organic carbonate solvents. In some cases, the flame retardant compound is a phosphorus compound, for example, a phosphazene compound. In some cases, the phosphazene compound is Ethoxy(pentafluoro)cyclotriphosphazene. In some cases, the electrochemical performance of the non-flammable electrolyte formulation is maintained by a combination of one or more cathode additives, one or more anode additives, and a binary system of lithium salts. In some cases, the electrochemical performance of the nonflammable electrolyte formulation is maintained by a primary cathode additive, an anode additive, a secondary, tertiary, and or a quaternary anode additive, and a binary or ternary system of lithium salts. In some embodiments, lithium ion energy storage devices comprising the nonflammable electrolyte formulation do not undergo degradation as to produce gaseous byproducts which increase on intracellular pressure of the energy storage device, thereby preventing an increase in temperature and or pressure within the energy storage device, and improving the safety and thermal operating window of the energy storage device. In some embodiments, energy storage devices utilizing the non-flammable electrolyte formulation of the present disclosure provides a similar or equivalent level of electrochemical performance as commercially available electrolytes that are flammable. And some embodiments, the nonflammable electrolyte formulations of the present disclosure provide for energy storage devices that maintain 80% or greater capacity retention at 1000 cycles. In some embodiments, the nonflammable electrolyte formulations of the present disclosure provide for energy storage devices that maintain 85% or greater capacity retention at 500 cycles. In some embodiments, the nonflammable electrolyte formulation of the present disclosure does not undergo thermal degradation when operated at 60 °C or higher for extended periods. In some embodiments, the nonflammable electrolyte formulation of the present disclosure is compatible with sulfur compounds, even at high temperatures. In some embodiments, the nonflammable electrolyte formulation of the present disclosure enhances the thermal stability of the nonflammable electrolyte formulation comprising a carbonate system comprising one or more sulfur compounds.

While various embodiments of the disclosure have been shown and described herein, it will be obvious to those skilled in the art that such embodiments are provided by way of example only. Numerous variations, changes, and substitutions may occur to those skilled in the art without departing from the disclosure. It should be understood that various alternatives to the embodiments of the disclosure described herein may be employed.

### DEFINITIONS

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, “w/w” refers to a dry weight by weight ratio.

As used herein, the term “flammable” refers to substance that can be ignited, causing fire or combustion an explosion. In some embodiments, a flammable material is classified under the U.S. government's Hazardous Materials Identification System (HMIS) as rating 1 (materials that must be preheated before they ignite), rating 2 (materials that must be moderately heated or exposed to relatively high ambient temperatures before they ignite), rating 3 (materials that can ignite under almost all temperature conditions, or rating 4 (materials that rapidly vaporize at atmospheric pressure and normal temperatures, or readily disperse in air and burn readily natural).

As used herein, the term “non-flammable” refers to a substance that cannot be ignited, or that can only be ignited under certain conditions. In some embodiments, a flammable material is classified under the U.S. government's Hazardous Materials Identification System (HMIS) as rating 0 (materials that do not burn), rating 1 (materials that must be preheated before they ignite), or rating 2 (materials that must be moderately heated or exposed to relatively high ambient temperatures before they ignite).

### Formulations

In an aspect of the present disclosure is a non-flammable electrolyte formulation comprising one or more non-aqueous organic solvents, a cathode additive, one or more anode additives, and one or more lithium salts, a non-flammable material comprising phosphazene in an amount of greater than 5% up to 25% w/w of the formulation, wherein the formulation is self-extinguishing or does not combust when exposed to flame.

In an aspect of the present disclosure is a non-flammable electrolyte formulation comprising one or more non-aqueous organic solvents, a cathode additive comprising a nitrile moiety, one or more anode additives, one or more lithium salts, and a non-flammable material comprising an amount of greater than 5% up to 25% w/w of the formulation.

In an aspect of the present disclosure is a non-flammable electrolyte formulation comprising one or more non-aqueous organic solvents, a cathode additive, one or more anode additives, one or more lithium salts, and a non-flammable material, wherein the electrolyte formulation is non-flammable when exposed to flame, or does not undergo thermal decomposition when heated to a temperature of 60 °C for 12 days.

In an aspect of the present disclosure is a non-flammable electrolyte formulation comprising one or more non-aqueous organic solvents, a cathode additive, one or more lithium salts, one or more anode additives comprising LiBOB, VC, and PS, wherein PS is the only sulfur compound in the formulation, and a non-flammable material.

In an aspect of the present disclosure is a non-flammable electrolyte formulation comprising one or more non-aqueous organic solvents, a cathode additive, one or more lithium salts, one or more anode additives, and a non-flammable material, wherein the one or more lithium salts and the one or more anode additives do not produce decomposition products at 60 °C up to 12 days.

In an aspect of the present disclosure is a non-flammable electrolyte formulation comprising one or more non-aqueous organic solvents, a cathode additive, a binary system of lithium salts comprising 2 of: Lithium Hexafluorophosphate, Lithium Tetrafluoroborate, Lithium Bis(fluorosulfonyl) Imide, or Lithium Bis(trifluoromethylsulfonyl) Imide, one or more anode additives, and a non-flammable material comprising phosphazene in an amount of greater than 5% up to 25% w/w of the formulation.

### Nonaqueous Solvents

Electrolytes provide a medium for the movement of ions between the anode and cathode of an energy storage device. In some embodiments, the electrolyte comprises a salt (e.g. a lithium salt), solvent, and one or more cycling stability additives. The salts, solvents, and additives herein form an electrolyte that functions at high temperatures without igniting, with stable energy performance. The affordability of the electrolyte components and the efficient methods for forming such electrolytes herein provide a solution to improving the safety of energy storage devices in commercial electronics.

In some embodiments, the nonaqueous organic solvents comprise one or more of alkyl carbonates, an ester organic solvent, or a fluoroether. In some embodiments, the alkyl carbonate comprises one or more of ethylene carbonate (EC), propylene carbonate (PC), ethyl methyl carbonate (EMC), dimethyl carbonate (DMC), or diethyl carbonate (DEC).

In some embodiments, the one or more non-aqueous organic solvents comprise ethylene carbonate (EC), propylene carbonate (PC), diethyl carbonate (DEC), ethyl methyl carbonate (EMC), gamma-butyrlactone (GBL), or 1, 1,2, 2-Tetrafluoroethyl-2, 2,3,3-tetrafluoropropyl ether (FEP).

In some embodiments, the formulation comprises at most four non-aqueous organic solvents.

In some embodiments, the formulation comprises EC, DEC, and EMC.

In some embodiments, the formulation comprises GBL and FEP. In some embodiments, the formulation comprises GBL and FEP wherein the GBL is included at a higher amount than FEP.

In some embodiments, the formulation comprises GBL at about 1 wt % to about 15 wt %. In some embodiments, the formulation comprises GBL at about 1 wt % to about 3 wt %, about 1 wt % to about 5 wt %, about 1 wt % to about 6 wt %, about 1 wt % to about 7 wt %, about 1 wt % to about 8 wt %, about 1 wt % to about 9 wt %, about 1 wt % to about 10 wt %, about 1 wt % to about 12 wt %, about 1 wt % to about 13 wt %, about 1 wt % to about 15 wt %, about 3 wt % to about 5 wt %, about 3 wt % to about 6 wt %, about 3 wt % to about 7 wt %, about 3 wt % to about 8 wt %, about 3 wt % to about 9 wt %, about 3 wt % to about 10 wt %, about 3 wt % to about 12 wt %, about 3 wt % to about 13 wt %, about 3 wt % to about 15 wt %, about 5 wt % to about 6 wt %, about 5 wt % to about 7 wt %, about 5 wt % to about 8 wt %, about 5 wt % to about 9 wt %, about 5 wt % to about 10 wt %, about 5 wt % to about 12 wt %, about 5 wt % to about 13 wt %, about 5 wt % to about 15 wt %, about 6 wt % to about 7 wt %, about 6 wt % to about 8 wt %, about 6 wt % to about 9 wt %, about 6 wt % to about 10 wt %, about 6 wt % to about 12 wt %, about 6 wt % to about 13 wt %, about 6 wt % to about 15 wt %, about 7 wt % to about 8 wt %, about 7 wt % to about 9 wt %, about 7 wt % to about 10 wt %, about 7 wt % to about 12 wt %, about 7 wt % to about 13 wt %, about 7 wt % to about 15 wt %, about 8 wt % to about 9 wt %, about 8 wt % to about 10 wt %, about 8 wt % to about 12 wt %, about 8 wt % to about 13 wt %, about 8 wt % to about 15 wt %, about 9 wt % to about 10 wt %, about 9 wt % to about 12 wt %, about 9 wt % to about 13 wt %, about 9 wt % to about 15 wt %, about 10 wt % to about 12 wt %, about 10 wt % to about 13 wt %, about 10 wt % to about 15 wt %, about 12 wt % to about 13 wt %, about 12 wt % to about 15 wt %, or about 13 wt % to about 15 wt %. In some embodiments, the formulation comprises GBL at about 1 wt %, about 3 wt %, about 5 wt %, about 6 wt %, about 7 wt %, about 8 wt %, about 9 wt %, about 10 wt %, about 12 wt %, about 13 wt %, or about 15 wt %. In some embodiments, the formulation comprises GBL at least about 1 wt %, about 3 wt %, about 5 wt %, about 6 wt %, about 7 wt %, about 8 wt %, about 9 wt %, about 10 wt %, about 12 wt %, or about 13 wt %. In some embodiments, the formulation comprises GBL at at most about 3 wt %, about 5 wt %, about 6 wt %, about 7 wt %, about 8 wt %, about 9 wt %, about 10 wt %, about 12 wt %, about 13 wt %, or about 15 wt %.

In some embodiments, the formulation comprises GBL at about 20 wt % to about 70 wt %. In some embodiments, the formulation comprises GBL at about 20 wt % to about 30 wt %, about 20 wt % to about 40 wt %, about 20 wt % to about 50 wt %, about 20 wt % to about 60 wt %, about 20 wt % to about 70 wt %, about 30 wt % to about 40 wt %, about 30 wt % to about 50 wt %, about 30 wt % to about 60 wt %, about 30 wt % to about 70 wt %, about 40 wt % to about 50 wt %, about 40 wt % to about 60 wt %, about 40 wt % to about 70 wt %, about 50 wt % to about 60 wt %, about 50 wt % to about 70 wt %, or about 60 wt % to about 70 wt %. In some embodiments, the formulation comprises GBL at about 20 wt %, about 30 wt %, about 40 wt %, about 50 wt %, about 60 wt %, about 62 wt %, about 65 wt %, or about 70 wt %. In some embodiments, the formulation comprises GBL at least about 20 wt %, about 30 wt %, about 40 wt %, about 50 wt %, or about 60 wt %. In some embodiments, the formulation comprises GBL at most about 30 wt %, about 40 wt %, about 50 wt %, about 60 wt %, about 65 wt %, or about 70 wt %.

In some embodiments, the formulation comprises FEP at about 0.5 wt % to about 10 wt %. In some embodiments, the formulation comprises FEP at about 0.5 wt % to about 1 wt %, about 0.5 wt % to about 2 wt %, about 0.5 wt % to about 3 wt %, about 0.5 wt % to about 4 wt %, about 0.5 wt % to about 5 wt %, about 0.5 wt % to about 6 wt %, about 0.5 wt % to about 8 wt %, about 0.5 wt % to about 10 wt %, about 1 wt % to about 2 wt %, about 1 wt % to about 3 wt %, about 1 wt % to about 4 wt %, about 1 wt % to about 5 wt %, about 1 wt % to about 6 wt %, about 1 wt % to about 8 wt %, about 1 wt % to about 10 wt %, about 2 wt % to about 3 wt %, about 2 wt % to about 4 wt %, about 2 wt % to about 5 wt %, about 2 wt % to about 6 wt %, about 2 wt % to about 8 wt %, about 2 wt % to about 10 wt %, about 3 wt % to about 4 wt %, about 3 wt % to about 5 wt %, about 3 wt % to about 6 wt %, about 3 wt % to about 8 wt %, about 3 wt % to about 10 wt %, about 4 wt % to about 5 wt %, about 4 wt % to about 6 wt %, about 4 wt % to about 8 wt %, about 4 wt % to about 10 wt %, about 5 wt % to about 6 wt %, about 5 wt % to about 8 wt %, about 5 wt % to about 10 wt %, about 6 wt % to about 8 wt %, about 6 wt % to about 10 wt %, or about 8 wt % to about 10 wt %. In some embodiments, the formulation comprises FEP at about 0.5 wt %, about 1 wt %, about 2 wt %, about 3 wt %, about 4 wt %, about 5 wt %, about 6 wt %, about 8 wt %, or about 10 wt %. In some embodiments, the formulation comprises FEP at at least about 0.5 wt %, about 1 wt %, about 2 wt %, about 3 wt %, about 4 wt %, about 5 wt %, about 6 wt %, or about 8 wt %. In some embodiments, the formulation comprises FEP at at most about 1 wt %, about 2 wt %, about 3 wt %, about 4 wt %, about 5 wt %, about 6 wt %, about 8 wt %, or about 10 wt %.

In some embodiments, the formulation comprises FEP at about 10 wt % to about 35 wt %. In some embodiments, the formulation comprises FEP at about 10 wt % to about 15 wt %, about 10 wt % to about 20 wt %, about 10 wt % to about 25 wt %, about 10 wt % to about 30 wt %, about 10 wt % to about 35 wt %, about 15 wt % to about 20 wt %, about 15 wt % to about 25 wt %, about 15 wt % to about 30 wt %, about 15 wt % to about 35 wt %, about 20 wt % to about 25 wt %, about 20 wt % to about 30 wt %, about 20 wt % to about 35 wt %, about 25 wt % to about 30 wt %, about 25 wt % to about 35 wt %, or about 30 wt % to about 35 wt %. In some embodiments, the formulation comprises FEP at about 10 wt %, about 15 wt %, about 20 wt %, about 25 wt %, about 30 wt %, or about 35 wt %. In some embodiments, the formulation comprises FEP at least about 10 wt %, about 15 wt %, about 20 wt %, about 25 wt %, or about 30 wt %. In some embodiments, the formulation comprises FEP at most about 15 wt %, about 20 wt %, about 25 wt %, about 30 wt %, or about 35 wt %.

In some embodiments, the one or more nonaqueous solvents comprise ethylene carbonate (EC), propylene carbonate (PC), dimethylcarbonate (DMC), ethyl methyl carbonate (EMC), diethyl carbonate (DEC), or any combinations thereof.

In some embodiments, the formulation comprises at most three nonaqueous solvents. In some embodiments, the formulation comprises one, two, three, four, or five nonaqueous solvents.

In some embodiments, the formulation comprises EC at about 0.5 wt % to about 10 wt %. In some embodiments, the formulation comprises EC at about 0.5 wt % to about 1 wt %, about 0.5 wt % to about 2 wt %, about 0.5 wt % to about 3 wt %, about 0.5 wt % to about 4 wt %, about 0.5 wt % to about 5 wt %, about 0.5 wt % to about 6 wt %, about 0.5 wt % to about 8 wt %, about 0.5 wt % to about 10 wt %, about 1 wt % to about 2 wt %, about 1 wt % to about 3 wt %, about 1 wt % to about 4 wt %, about 1 wt % to about 5 wt %, about 1 wt % to about 6 wt %, about 1 wt % to about 8 wt %, about 1 wt % to about 10 wt %, about 2 wt % to about 3 wt %, about 2 wt % to about 4 wt %, about 2 wt % to about 5 wt %, about 2 wt % to about 6 wt %, about 2 wt % to about 8 wt %, about 2 wt % to about 10 wt %, about 3 wt % to about 4 wt %, about 3 wt % to about 5 wt %, about 3 wt % to about 6 wt %, about 3 wt % to about 8 wt %, about 3 wt % to about 10 wt %, about 4 wt % to about 5 wt %, about 4 wt % to about 6 wt %, about 4 wt % to about 8 wt %, about 4 wt % to about 10 wt %, about 5 wt % to about 6 wt %, about 5 wt % to about 8 wt %, about 5 wt % to about 10 wt %, about 6 wt % to about 8 wt %, about 6 wt % to about 10 wt %, or about 8 wt % to about 10 wt %. In some embodiments, the formulation comprises EC at about 0.5 wt %, about 1 wt %, about 2 wt %, about 3 wt %, about 4 wt %, about 5 wt %, about 6 wt %, about 8 wt %, or about 10 wt %. In some embodiments, the formulation comprises EC at least about 0.5 wt %, about 1 wt %, about 2 wt %, about 3 wt %, about 4 wt %, about 5 wt %, about 6 wt %, or about 8 wt %. In some embodiments, the formulation comprises EC at most about 1 wt %, about 2 wt %, about 3 wt %, about 4 wt %, about 5 wt %, about 6 wt %, about 8 wt %, or about 10 wt %.

In some embodiments, the formulation comprises EC at about 10 wt % to about 35 wt %. In some embodiments, the formulation comprises EC at about 10 wt % to about 15 wt %, about 10 wt % to about 20 wt %, about 10 wt % to about 25 wt %, about 10 wt % to about 30 wt %, about 10 wt % to about 35 wt %, about 15 wt % to about 20 wt %, about 15 wt % to about 25 wt %, about 15 wt % to about 30 wt %, about 15 wt % to about 35 wt %, about 20 wt % to about 25 wt %, about 20 wt % to about 30 wt %, about 20 wt % to about 35 wt %, about 25 wt % to about 30 wt %, about 25 wt % to about 35 wt %, or about 30 wt % to about 35 wt %. In some embodiments, the formulation comprises EC at about 10 wt %, about 15 wt %, about 16 wt %, about 17 wt %, about 18 wt %, about 19 wt %, about 20 wt %, about 25 wt %, about 30 wt %, or about 35 wt %. In some embodiments, the formulation comprises EC at least about 10 wt %, about 15 wt %, about 16 wt %, about 17 wt %, about 18 wt %, about 19 wt %, about 20 wt %, about 25 wt %, or about 30 wt %. In some embodiments, the formulation comprises EC at at most about 15 wt %, about 16 wt %, about 17 wt %, about 18 wt %, about 19 wt %, about 20 wt %, about 25 wt %, about 30 wt %, or about 35 wt %.

In some embodiments, the formulation comprises PC at about 1 wt % to about 10 wt %. In some embodiments, the formulation comprises PC at about 0.5 wt % to about 11 wt %. In some embodiments, the formulation comprises PC at about 0.5 wt % to about 1 wt %, about 0.5 wt % to about 2 wt %, about 0.5 wt % to about 3 wt %, about 0.5 wt % to about 4 wt %, about 0.5 wt % to about 5 wt %, about 0.5 wt % to about 6 wt %, about 0.5 wt % to about 7 wt %, about 0.5 wt % to about 8 wt %, about 0.5 wt % to about 9 wt %, about 0.5 wt % to about 10 wt %, about 0.5 wt % to about 11 wt %, about 1 wt % to about 2 wt %, about 1 wt % to about 3 wt %, about 1 wt % to about 4 wt %, about 1 wt % to about 5 wt %, about 1 wt % to about 6 wt %, about 1 wt % to about 7 wt %, about 1 wt % to about 8 wt %, about 1 wt % to about 9 wt %, about 1 wt % to about 10 wt %, about 1 wt % to about 11 wt %, about 2 wt % to about 3 wt %, about 2 wt % to about 4 wt %, about 2 wt % to about 5 wt %, about 2 wt % to about 6 wt %, about 2 wt % to about 7 wt %, about 2 wt % to about 8 wt %, about 2 wt % to about 9 wt %, about 2 wt % to about 10 wt %, about 2 wt % to about 11 wt %, about 3 wt % to about 4 wt %, about 3 wt % to about 5 wt %, about 3 wt % to about 6 wt %, about 3 wt % to about 7 wt %, about 3 wt % to about 8 wt %, about 3 wt % to about 9 wt %, about 3 wt % to about 10 wt %, about 3 wt % to about 11 wt %, about 4 wt % to about 5 wt %, about 4 wt % to about 6 wt %, about 4 wt % to about 7 wt %, about 4 wt % to about 8 wt %, about 4 wt % to about 9 wt %, about 4 wt % to about 10 wt %, about 4 wt % to about 11 wt %, about 5 wt % to about 6 wt %, about 5 wt % to about 7 wt %, about 5 wt % to about 8 wt %, about 5 wt % to about 9 wt %, about 5 wt % to about 10 wt %, about 5 wt % to about 11 wt %, about 6 wt % to about 7 wt %, about 6 wt % to about 8 wt %, about 6 wt % to about 9 wt %, about 6 wt % to about 10 wt %, about 6 wt % to about 11 wt %, about 7 wt % to about 8 wt %, about 7 wt % to about 9 wt %, about 7 wt % to about 10 wt %, about 7 wt % to about 11 wt %, about 8 wt % to about 9 wt %, about 8 wt % to about 10 wt %, about 8 wt % to about 11 wt %, about 9 wt % to about 10 wt %, about 9 wt % to about 11 wt %, or about 10 wt % to about 11 wt %. In some embodiments, the formulation comprises PC at about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, or about 11 wt %. In some embodiments, the formulation comprises PC at least about 0.5 wt %, about 1 wt %, about 2 wt %, about 3 wt %, about 4 wt %, about 5 wt %, about 6 wt %, about 7 wt %, about 8 wt %, about 9 wt %, or about 10 wt %. In some embodiments, the formulation comprises PC at most about 1 wt %, about 2 wt %, about 3 wt %, about 4 wt %, about 5 wt %, about 6 wt %, about 7 wt %, about 8 wt %, about 9 wt %, about 10 wt %, or about 11 wt %.

In some embodiments, the formulation comprises DEC at about 0.5 wt % to about 12 wt %. In some embodiments, the formulation comprises DEC at about 0.5 wt % to about 1 wt %, about 0.5 wt % to about 2 wt %, about 0.5 wt % to about 3 wt %, about 0.5 wt % to about 4 wt %, about 0.5 wt % to about 5 wt %, about 0.5 wt % to about 6 wt %, about 0.5 wt % to about 7 wt %, about 0.5 wt % to about 8 wt %, about 0.5 wt % to about 9 wt %, about 0.5 wt % to about 10 wt %, about 0.5 wt % to about 12 wt %, about 1 wt % to about 2 wt %, about 1 wt % to about 3 wt %, about 1 wt % to about 4 wt %, about 1 wt % to about 5 wt %, about 1 wt % to about 6 wt %, about 1 wt % to about 7 wt %, about 1 wt % to about 8 wt %, about 1 wt % to about 9 wt %, about 1 wt % to about 10 wt %, about 1 wt % to about 12 wt %, about 2 wt % to about 3 wt %, about 2 wt % to about 4 wt %, about 2 wt % to about 5 wt %, about 2 wt % to about 6 wt %, about 2 wt % to about 7 wt %, about 2 wt % to about 8 wt %, about 2 wt % to about 9 wt %, about 2 wt % to about 10 wt %, about 2 wt % to about 12 wt %, about 3 wt % to about 4 wt %, about 3 wt % to about 5 wt %, about 3 wt % to about 6 wt %, about 3 wt % to about 7 wt %, about 3 wt % to about 8 wt %, about 3 wt % to about 9 wt %, about 3 wt % to about 10 wt %, about 3 wt % to about 12 wt %, about 4 wt % to about 5 wt %, about 4 wt % to about 6 wt %, about 4 wt % to about 7 wt %, about 4 wt % to about 8 wt %, about 4 wt % to about 9 wt %, about 4 wt % to about 10 wt %, about 4 wt % to about 12 wt %, about 5 wt % to about 6 wt %, about 5 wt % to about 7 wt %, about 5 wt % to about 8 wt %, about 5 wt % to about 9 wt %, about 5 wt % to about 10 wt %, about 5 wt % to about 12 wt %, about 6 wt % to about 7 wt %, about 6 wt % to about 8 wt %, about 6 wt % to about 9 wt %, about 6 wt % to about 10 wt %, about 6 wt % to about 12 wt %, about 7 wt % to about 8 wt %, about 7 wt % to about 9 wt %, about 7 wt % to about 10 wt %, about 7 wt % to about 12 wt %, about 8 wt % to about 9 wt %, about 8 wt % to about 10 wt %, about 8 wt % to about 12 wt %, about 9 wt % to about 10 wt %, about 9 wt % to about 12 wt %, or about 10 wt % to about 12 wt %. In some embodiments, the formulation comprises DEC at about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, or about 12 wt %. In some embodiments, the formulation comprises DEC at at least about 0.5 wt %, about 1 wt %, about 2 wt %, about 3 wt %, about 4 wt %, about 5 wt %, about 6 wt %, about 7 wt %, about 8 wt %, about 9 wt %, or about 10 wt %. In some embodiments, the formulation comprises DEC at at most about 1 wt %, about 2 wt %, about 3 wt %, about 4 wt %, about 5 wt %, about 6 wt %, about 7 wt %, about 8 wt %, about 9 wt %, about 10 wt %, or about 12 wt %.

In some embodiments, the formulation comprises DEC at about 10 wt % to about 35 wt %. In some embodiments, the formulation comprises DEC at about 10 wt % to about 15 wt %, about 10 wt % to about 20 wt %, about 10 wt % to about 25 wt %, about 10 wt % to about 30 wt %, about 10 wt % to about 35 wt %, about 15 wt % to about 20 wt %, about 15 wt % to about 25 wt %, about 15 wt % to about 30 wt %, about 15 wt % to about 35 wt %, about 20 wt % to about 25 wt %, about 20 wt % to about 30 wt %, about 20 wt % to about 35 wt %, about 25 wt % to about 30 wt %, about 25 wt % to about 35 wt %, or about 30 wt % to about 35 wt %. In some embodiments, the formulation comprises DEC at about 10 wt %, about 15 wt %, about 16 wt %, about 17 wt %, about 18 wt %, about 19 wt %, about 20 wt %, about 25 wt %, about 30 wt %, or about 35 wt %. In some embodiments, the formulation comprises DEC at least about 10 wt %, about 15 wt %, about 16 wt %, about 17 wt %, about 18 wt %, about 19 wt %, about 20 wt %, about 25 wt %, or about 30 wt %. In some embodiments, the formulation comprises DEC at most about 15 wt %, about 16 wt %, about 17 wt %, about 18 wt %, about 19 wt %, about 20 wt %, about 25 wt %, about 30 wt %, or about 35 wt %.

In some embodiments, the formulation comprises EMC at about 0.5 wt % to about 12 wt %. In some embodiments, the formulation comprises EMC at about 0.5 wt % to about 1 wt %, about 0.5 wt % to about 2 wt %, about 0.5 wt % to about 3 wt %, about 0.5 wt % to about 4 wt %, about 0.5 wt % to about 5 wt %, about 0.5 wt % to about 6 wt %, about 0.5 wt % to about 7 wt %, about 0.5 wt % to about 8 wt %, about 0.5 wt % to about 9 wt %, about 0.5 wt % to about 10 wt %, about 0.5 wt % to about 12 wt %, about 1 wt % to about 2 wt %, about 1 wt % to about 3 wt %, about 1 wt % to about 4 wt %, about 1 wt % to about 5 wt %, about 1 wt % to about 6 wt %, about 1 wt % to about 7 wt %, about 1 wt % to about 8 wt %, about 1 wt % to about 9 wt %, about 1 wt % to about 10 wt %, about 1 wt % to about 12 wt %, about 2 wt % to about 3 wt %, about 2 wt % to about 4 wt %, about 2 wt % to about 5 wt %, about 2 wt % to about 6 wt %, about 2 wt % to about 7 wt %, about 2 wt % to about 8 wt %, about 2 wt % to about 9 wt %, about 2 wt % to a bout 10 wt %, about 2 wt % to about 12 wt %, about 3 wt % to about 4 wt %, about 3 wt % to about 5 wt %, about 3 wt % to about 6 wt %, about 3 wt % to about 7 wt %, about 3 wt % to about 8 wt %, about 3 wt % to about 9 wt %, about 3 wt % to about 10 wt %, about 3 wt % to about 12 wt %, about 4 wt % to about 5 wt %, about 4 wt % to about 6 wt %, about 4 wt % to about 7 wt %, about 4 wt % to about 8 wt %, about 4 wt % to about 9 wt %, about 4 wt % to about 10 wt %, about 4 wt % to about 12 wt %, about 5 wt % to about 6 wt %, about 5 wt % to about 7 wt %, about 5 wt % to about 8 wt %, about 5 wt % to about 9 wt %, about 5 wt % to about 10 wt %, about 5 wt % to about 12 wt %, about 6 wt % to about 7 wt %, about 6 wt % to about 8 wt %, about 6 wt % to about 9 wt %, about 6 wt % to about 10 wt %, about 6 wt % to about 12 wt %, about 7 wt % to about 8 wt %, about 7 wt % to about 9 wt %, about 7 wt % to about 10 wt %, about 7 wt % to about 12 wt %, about 8 wt % to about 9 wt %, about 8 wt % to about 10 wt %, about 8 wt % to about 12 wt %, about 9 wt % to about 10 wt %, about 9 wt % to about 12 wt %, or about 10 wt % to about 12 wt %. In some embodiments, the formulation comprises EMC at about 0.5 wt %, about 1 wt %, about 2 wt %, about 3 wt %, about 4 wt %, about 5 wt %, about 6 wt %, about 7 wt %, about 8 wt %, about 9 wt %, about 10 wt %, or about 12 wt %. In some embodiments, the formulation comprises EMC at at least about 0.5 wt %, about 1 wt %, about 2 wt %, about 3 wt %, about 4 wt %, about 5 wt %, about 6 wt %, about 7 wt %, about 8 wt %, about 9 wt %, or about 10 wt %. In some embodiments, the formulation comprises EMC at at most about 1 wt %, about 2 wt %, about 3 wt %, about 4 wt %, about 5 wt %, about 6 wt %, about 7 wt %, about 8 wt %, about 9 wt %, about 10 wt %, or about 12 wt %.

In some embodiments, the formulation comprises EMC at about 10 wt % to about 35 wt %. In some embodiments, the formulation comprises EMC at about 10 wt % to about 15 wt %, about 10 wt % to about 20 wt %, about 10 wt % to about 25 wt %, about 10 wt % to about 30 wt %, about 10 wt % to about 35 wt %, about 15 wt % to about 20 wt %, about 15 wt % to about 25 wt %, about 15 wt % to about 30 wt %, about 15 wt % to about 35 wt %, about 20 wt % to about 25 wt %, about 20 wt % to about 30 wt %, about 20 wt % to about 35 wt %, about 25 wt % to about 30 wt %, about 25 wt % to about 35 wt %, or about 30 wt % to about 35 wt %. In some embodiments, the formulation comprises EMC at about 10 wt %, about 15 wt %, about 20 wt %, about 25 wt %, about 30 wt %, or about 35 wt %. In some embodiments, the formulation comprises EMC at least about 10 wt %, about 15 wt %, about 20 wt %, about 25 wt %, or about 30 wt %. In some embodiments, the formulation comprises EMC at most about 15 wt %, about 20 wt %, about 25 wt %, about 30 wt %, or about 35 wt %.

### Lithium Salts

In some embodiments, the formulation comprises two or more lithium salts. In some embodiments, the formulation comprises one or more lithium salts. In some embodiments, the formulation comprises three or more lithium salts. In some embodiments, the formulation comprises a binary lithium salt system. In some embodiments, the formulation comprises one or more lithium salts selected from s, LiPF₆, and LiTFSI. In some embodiments, the two or more lithium salts comprises LiPF₆ (Lithium hexafluorophosphate) and LiTFSI (Lithium bis(trifluoromethane)sulfonimide). In some embodiments, the formulation comprises a binary lithium salt system consisting of LiBF₄ and LiPF₆. In some embodiments, the formulation comprises a binary lithium salt system consisting of LiBF₄ and LiTFSI. In some embodiments, the formulation comprises a binary lithium salt system consisting of LiPF₆ and LiTFSI.

In some embodiments, the one or more lithium salts are selected from Lithium Hexafluorophosphate, Lithium Tetrafluoroborate, Lithium Bis(fluorosulfonyl) Imide, and Lithium Bis(trifluoromethylsulfonyl) Imide.

In some embodiments, the one or more lithium salts are a binary system of lithium salts consisting of two of: Lithium Hexafluorophosphate, Lithium Tetrafluoroborate, Lithium Bis(fluorosulfonyl) Imide, or Lithium Bis(trifluoromethylsulfonyl) Imide.

In some embodiments, the one or more lithium salts comprises LiPF₆ or LiBF₄. In some embodiments, the one or more lithium salts is two lithium salts. In some embodiments, the two lithium salts are LiPF₆ and LiBF₄.

In some embodiments, the one or more lithium salts comprise one or more of lithium hexafluorophosphate, lithium tetrafluoroborate, lithium bis(fluorosulfonyl)imide, or lithium bis(trifluoromethylsulfonyl)imide.

In some embodiments, the formulation comprises about 0.8M to about 1.6M of each of the one or more lithium salts by concentration of the electrolyte.

In some embodiments, the formulation comprises about 0.3 M to about 2 M of each of the one or more lithium salts by concentration of the electrolyte. In some embodiments, the formulation comprises about 0.3 M to about 0.6 M, about 0.3 M to about 0.8 M, about 0.3 M to about 1 M, about 0.3 M to about 1.2 M, about 0.3 M to about 1.4 M, about 0.3 M to about 1.6 M, about 0.3 M to about 1.8 M, about 0.3 M to about 2 M, about 0.6 M to about 0.8 M, about 0.6 M to about 1 M, about 0.6 M to about 1.2 M, about 0.6 M to about 1.4 M, about 0.6 M to about 1.6 M, about 0.6 M to about 1.8 M, about 0.6 M to about 2 M, about 0.8 M to about 1 M, about 0.8 M to about 1.2 M, about 0.8 M to about 1.4 M, about 0.8 M to about 1.6 M, about 0.8 M to about 1.8 M, about 0.8 M to about 2 M, about 1 M to about 1.2 M, about 1 M to about 1.4 M, about 1 M to about 1.6 M, about 1 M to about 1.8 M, about 1 M to about 2 M, about 1.2 M to about 1.4 M, about 1.2 M to about 1.6 M, about 1.2 M to about 1.8 M, about 1.2 M to about 2 M, about 1.4 M to about 1.6 M, about 1.4 M to about 1.8 M, about 1.4 M to about 2 M, about 1.6 M to about 1.8 M, about 1.6 M to about 2 M, or about 1.8 M to about 2 M of each of the one or more lithium salts by concentration of the electrolyte. In some embodiments, the formulation comprises about 0.3 M, about 0.6 M, about 0.8 M, about 1 M, about 1.2 M, about 1.4 M, about 1.6 M, about 1.8 M, or about 2 M. In some embodiments, the formulation comprises at least about 0.3 M, about 0.6 M, about 0.8 M, about 1 M, about 1.2 M, about 1.4 M, about 1.6 M, or about 1.8 M. In some embodiments, the formulation comprises at most about 0.6 M, about 0.8 M, about 1 M, about 1.2 M, about 1.4 M, about 1.6 M, about 1.8 M, or about 2 M of each of the one or more lithium salts by concentration of the electrolyte.

### Cathode Additive

In some embodiments, the formulation comprises a cathode additive. In some embodiments, the cathode additive comprises one or more of HTCN [1,3,6-Hexanetricarbonitrile], succinonitrile, or adiponitrile. In some embodiments, the cathode additive comprises HTCN [1,3,6-Hexanetricarbonitrile]. In some embodiments, the cathode additive comprises succinonitrile. In some embodiments, the cathode additive comprises adiponitrile.

In some embodiments, the formulation comprises about 0.5 wt % to about 5 wt % of the cathode additive by total electrolyte weight. In some embodiments, the formulation comprises at least about 0.5% wt of the cathode additive by total electrolyte weight. In some embodiments, the formulation comprises up to about 5 wt % of the cathode additive by total electrolyte weight. In some embodiments, the HTCN is included in the formulation in an amount of at least 0.5% wt, 1.0% wt, 1.5% wt, 2.5% wt, 3.0% wt, or 3.5% wt. In some embodiments, the HTCN is included in the formulation in an amount of at most 0.5% wt, 1.0% wt, 1.5% wt, 2.5% wt, 3.0% wt, or 3.5% wt.

In some embodiments, the formulation comprises about 0.5 wt % to about 5 wt % of HTCN by total electrolyte weight. In some embodiments, the formulation comprises up to about 5 wt % of HTCN by total electrolyte weight. In some embodiments, the formulation comprises about 0.1 wt % to about 5 wt % of HTCN by total electrolyte weight. In some embodiments, the formulation comprises about 0.1 wt % to about 0.25 wt %, about 0.1 wt % to about 0.5 wt %, about 0.1 wt % to about 1 wt %, about 0.1 wt % to about 1.5 wt %, about 0.1 wt % to about 2 wt %, about 0.1 wt % to about 2.5 wt %, about 0.1 wt % to about 3 wt %, about 0.1 wt % to about 3.5 wt %, about 0.1 wt % to about 4 wt %, about 0.1 wt % to about 4.5 wt %, about 0.1 wt % to about 5 wt %, about 0.25 wt % to about 0.5 wt %, about 0.25 wt % to about 1 wt %, about 0.25 wt % to about 1.5 wt %, about 0.25 wt % to about 2 wt %, about 0.25 wt % to about 2.5 wt %, about 0.25 wt % to about 3 wt %, about 0.25 wt % to about 3.5 wt %, about 0.25 wt % to about 4 wt %, about 0.25 wt % to about 4.5 wt %, about 0.25 wt % to about 5 wt %, about 0.5 wt % to about 1 wt %, about 0.5 wt % to about 1.5 wt %, about 0.5 wt % to about 2 wt %, about 0.5 wt % to about 2.5 wt %, about 0.5 wt % to about 3 wt %, about 0.5 wt % to about 3.5 wt %, about 0.5 wt % to about 4 wt %, about 0.5 wt % to about 4.5 wt %, about 0.5 wt % to about 5 wt %, about 1 wt % to about 1.5 wt %, about 1 wt % to about 2 wt %, about 1 wt % to about 2.5 wt %, about 1 wt % to about 3 wt %, about 1 wt % to about 3.5 wt %, about 1 wt % to about 4 wt %, about 1 wt % to about 4.5 wt %, about 1 wt % to about 5 wt %, about 1.5 wt % to about 2 wt %, about 1.5 wt % to about 2.5 wt %, about 1.5 wt % to about 3 wt %, about 1.5 wt % to about 3.5 wt %, about 1.5 wt % to about 4 wt %, about 1.5 wt % to about 4.5 wt %, about 1.5 wt % to about 5 wt %, about 2 wt % to about 2.5 wt %, about 2 wt % to about 3 wt %, about 2 wt % to about 3.5 wt %, about 2 wt % to about 4 wt %, about 2 wt % to about 4.5 wt %, about 2 wt % to about 5 wt %, about 2.5 wt % to about 3 wt %, about 2.5 wt % to about 3.5 wt %, about 2.5 wt % to about 4 wt %, about 2.5 wt % to about 4.5 wt %, about 2.5 wt % to about 5 wt %, about 3 wt % to about 3.5 wt %, about 3 wt % to about 4 wt %, about 3 wt % to about 4.5 wt %, about 3 wt % to about 5 wt %, about 3.5 wt % to about 4 wt %, about 3.5 wt % to about 4.5 wt %, about 3.5 wt % to about 5 wt %, about 4 wt % to about 4.5 wt %, about 4 wt % to about 5 wt %, or about 4.5 wt % to about 5 wt % of HTCN by total electrolyte weight. In some embodiments, the formulation comprises about 0.1 wt %, about 0.25 wt %, about 0.5 wt %, about 1 wt %, about 1.5 wt %, about 2 wt %, about 2.5 wt %, about 3 wt %, about 3.5 wt %, about 4 wt %, about 4.5 wt %, or about 5 wt %. In some embodiments, the formulation comprises at least about 0.1 wt %, about 0.25 wt %, about 0.5 wt %, about 1 wt %, about 1.5 wt %, about 2 wt %, about 2.5 wt %, about 3 wt %, about 3.5 wt %, about 4 wt %, or about 4.5 wt % of HTCN by total electrolyte weight. In some embodiments, the formulation comprises at most about 0.25 wt %, about 0.5 wt %, about 1 wt %, about 1.5 wt %, about 2 wt %, about 2.5 wt %, about 3 wt %, about 3.5 wt %, about 4 wt %, about 4.5 wt %, or about 5 wt % of HTCN by total electrolyte weight.

### Anode Additive

In some embodiments, the formulation comprises one or more anode additives. In some embodiments, the one or more anode additives comprise one or more of LiBOB (Lithium bis(oxalate)borate), Lithium difluoro(oxalate)borate, vinylene carbonate, or PS (1,3-Propane sultone). In some embodiments, the formulation comprises four anode additives. In some embodiments, the formulation comprises three anode additives. In some embodiments, the formulation comprises one, two, three, or four anode additives. In some embodiments, the one or more anode additives comprises LiBOB, VC, PS, or any combination thereof. In some embodiments, the formulation comprises LiBOB, VC, and PS. In some embodiments, the formulation comprises LiBOB, VC, and PS, each in an amount of at least 0.5% wt. In some embodiments, the formulation comprises LiBOB, VC, and PS, each in an amount of at least 1% wt.

In some embodiments, the formulation comprises about 1 wt % to about 5 wt % of vinylene carbonate by total electrolyte weight. In some embodiments, the formulation comprises about 1 wt % to about 3 wt % of vinylene carbonate by total electrolyte weight. In some embodiments, the formulation comprises at least about 1.5 wt % of vinylene carbonate by total electrolyte weight.

In some embodiments, the formulation comprises about 0.1 wt % to about 5 wt % of vinylene carbonate by total electrolyte weight. In some embodiments, the formulation comprises about 0.1 wt % to about 0.5 wt %, about 0.1 wt % to about 1 wt %, about 0.1 wt % to about 1.5 wt %, about 0.1 wt % to about 2 wt %, about 0.1 wt % to about 2.5 wt %, about 0.1 wt % to about 3 wt %, about 0.1 wt % to about 3.5 wt %, about 0.1 wt % to about 4 wt %, about 0.1 wt % to about 4.5 wt %, about 0.1 wt % to about 5 wt %, about 0.5 wt % to about 1 wt %, about 0.5 wt % to about 1.5 wt %, about 0.5 wt % to about 2 wt %, about 0.5 wt % to about 2.5 wt %, about 0.5 wt % to about 3 wt %, about 0.5 wt % to about 3.5 wt %, about 0.5 wt % to about 4 wt %, about 0.5 wt % to about 4.5 wt %, about 0.5 wt % to about 5 wt %, about 1 wt % to about 1.5 wt %, about 1 wt % to about 2 wt %, about 1 wt % to about 2.5 wt %, about 1 wt % to about 3 wt %, about 1 wt % to about 3.5 wt %, about 1 wt % to about 4 wt %, about 1 wt % to about 4.5 wt %, about 1 wt % to about 5 wt %, about 1.5 wt % to about 2 wt %, about 1.5 wt % to about 2.5 wt %, about 1.5 wt % to about 3 wt %, about 1.5 wt % to about 3.5 wt %, about 1.5 wt % to about 4 wt %, about 1.5 wt % to about 4.5 wt %, about 1.5 wt % to about 5 wt %, about 2 wt % to about 2.5 wt %, about 2 wt % to about 3 wt %, about 2 wt % to about 3.5 wt %, about 2 wt % to about 4 wt %, about 2 wt % to about 4.5 wt %, about 2 wt % to about 5 wt %, about 2.5 wt % to about 3 wt %, about 2.5 wt % to about 3.5 wt %, about 2.5 wt % to about 4 wt %, about 2.5 wt % to about 4.5 wt %, about 2.5 wt % to about 5 wt %, about 3 wt % to about 3.5 wt %, about 3 wt % to about 4 wt %, about 3 wt % to about 4.5 wt %, about 3 wt % to about 5 wt %, about 3.5 wt % to about 4 wt %, about 3.5 wt % to about 4.5 wt %, about 3.5 wt % to about 5 wt %, about 4 wt % to about 4.5 wt %, about 4 wt % to about 5 wt %, or about 4.5 wt % to about 5 wt % of vinylene carbonate by total electrolyte weight. In some embodiments, the formulation comprises about 0.1 wt %, about 0.5 wt %, about 1 wt %, about 1.5 wt %, about 2 wt %, about 2.5 wt %, about 3 wt %, about 3.5 wt %, about 4 wt %, about 4.5 wt %, or about 5 wt % of vinylene carbonate by total electrolyte weight. In some embodiments, the formulation comprises at least about 0.1 wt %, about 0.5 wt %, about 1 wt %, about 1.5 wt %, about 2 wt %, about 2.5 wt %, about 3 wt %, about 3.5 wt %, about 4 wt %, or about 4.5 wt % of vinylene carbonate by total electrolyte weight. In some embodiments, the formulation comprises at most about 0.5 wt %, about 1 wt %, about 1.5 wt %, about 2 wt %, about 2.5 wt %, about 3 wt %, about 3.5 wt %, about 4 wt %, about 4.5 wt %, or about 5 wt % of vinylene carbonate by total electrolyte weight.

In some embodiments, the formulation comprises about 1 wt % to about 5 wt % of LiBOB by total electrolyte weight. In some embodiments, the formulation comprises at least about 1 wt % of LiBOB by total electrolyte weight.

In some embodiments, the formulation comprises about 0.1 wt % to about 5 wt % of LiBOB by total electrolyte weight. In some embodiments, the formulation comprises about 0.1 wt % to about 0.5 wt %, about 0.1 wt % to about 1 wt %, about 0.1 wt % to about 1.5 wt %, about 0.1 wt % to about 2 wt %, about 0.1 wt % to about 2.5 wt %, about 0.1 wt % to about 3 wt %, about 0.1 wt % to about 3.5 wt %, about 0.1 wt % to about 4 wt %, about 0.1 wt % to about 4.5 wt %, about 0.1 wt % to about 5 wt %, about 0.5 wt % to about 1 wt %, about 0.5 wt % to about 1.5 wt %, about 0.5 wt % to about 2 wt %, about 0.5 wt % to about 2.5 wt %, about 0.5 wt % to about 3 wt %, about 0.5 wt % to about 3.5 wt %, about 0.5 wt % to about 4 wt %, about 0.5 wt % to about 4.5 wt %, about 0.5 wt % to about 5 wt %, about 1 wt % to about 1.5 wt %, about 1 wt % to about 2 wt %, about 1 wt % to about 2.5 wt %, about 1 wt % to about 3 wt %, about 1 wt % to about 3.5 wt %, about 1 wt % to about 4 wt %, about 1 wt % to about 4.5 wt %, about 1 wt % to about 5 wt %, about 1.5 wt % to about 2 wt %, about 1.5 wt % to about 2.5 wt %, about 1.5 wt % to about 3 wt %, about 1.5 wt % to about 3.5 wt %, about 1.5 wt % to about 4 wt %, about 1.5 wt % to about 4.5 wt %, about 1.5 wt % to about 5 wt %, about 2 wt % to about 2.5 wt %, about 2 wt % to about 3 wt %, about 2 wt % to about 3.5 wt %, about 2 wt % to about 4 wt %, about 2 wt % to about 4.5 wt %, about 2 wt % to about 5 wt %, about 2.5 wt % to about 3 wt %, about 2.5 wt % to about 3.5 wt %, about 2.5 wt % to about 4 wt %, about 2.5 wt % to about 4.5 wt %, about 2.5 wt % to about 5 wt %, about 3 wt % to about 3.5 wt %, about 3 wt % to about 4 wt %, about 3 wt % to about 4.5 wt %, about 3 wt % to about 5 wt %, about 3.5 wt % to about 4 wt %, about 3.5 wt % to about 4.5 wt %, about 3.5 wt % to about 5 wt %, about 4 wt % to about 4.5 wt %, about 4 wt % to about 5 wt %, or about 4.5 wt % to about 5 wt % of LiBOB by total electrolyte weight. In some embodiments, the formulation comprises about 0.1 wt %, about 0.5 wt %, about 1 wt %, about 1.5 wt %, about 2 wt %, about 2.5 wt %, about 3 wt %, about 3.5 wt %, about 4 wt %, about 4.5 wt %, or about 5 wt % of LiBOB by total electrolyte weight. In some embodiments, the formulation comprises at least about 0.1 wt %, about 0.5 wt %, about 1 wt %, about 1.5 wt %, about 2 wt %, about 2.5 wt %, about 3 wt %, about 3.5 wt %, about 4 wt %, or about 4.5 wt % of LiBOB by total electrolyte weight. In some embodiments, the formulation comprises at most about 0.5 wt %, about 1 wt %, about 1.5 wt %, about 2 wt %, about 2.5 wt %, about 3 wt %, about 3.5 wt %, about 4 wt %, about 4.5 wt %, or about 5 wt % of LiBOB by total electrolyte weight.

In some embodiments, the formulation comprises about 1 wt % to about 5 wt % of 1,3-Propane sultone by total electrolyte weight. In some embodiments, the formulation comprises about 1 wt % to about 3 wt % of 1,3-Propane sultone by total electrolyte weight. In some embodiments, the formulation comprises at least about 0.5 wt % of 1,3-Propane sultone by total electrolyte weight.

In some embodiments, the formulation comprises about 0.1 wt % to about 3 wt % 1,3-Propane sultone. In some embodiments, the formulation comprises about 0.1 wt % to about 0.25 wt %, about 0.1 wt % to about 0.5 wt %, about 0.1 wt % to about 0.75 wt %, about 0.1 wt % to about 1 wt %, about 0.1 wt % to about 1.5 wt %, about 0.1 wt % to about 2 wt %, about 0.1 wt % to about 2.5 wt %, about 0.1 wt % to about 3 wt %, about 0.25 wt % to about 0.5 wt %, about 0.25 wt % to about 0.75 wt %, about 0.25 wt % to about 1 wt %, about 0.25 wt % to about 1.5 wt %, about 0.25 wt % to about 2 wt %, about 0.25 wt % to about 2.5 wt %, about 0.25 wt % to about 3 wt %, about 0.5 wt % to about 0.75 wt %, about 0.5 wt % to about 1 wt %, about 0.5 wt % to about 1.5 wt %, about 0.5 wt % to about 2 wt %, about 0.5 wt % to about 2.5 wt %, about 0.5 wt % to about 3 wt %, about 0.75 wt % to about 1 wt %, about 0.75 wt % to about 1.5 wt %, about 0.75 wt % to about 2 wt %, about 0.75 wt % to about 2.5 wt %, about 0.75 wt % to about 3 wt %, about 1 wt % to about 1.5 wt %, about 1 wt % to about 2 wt %, about 1 wt % to about 2.5 wt %, about 1 wt % to about 3 wt %, about 1.5 wt % to about 2 wt %, about 1.5 wt % to about 2.5 wt %, about 1.5 wt % to about 3 wt %, about 2 wt % to about 2.5 wt %, about 2 wt % to about 3 wt %, or about 2.5 wt % to about 3 wt % 1,3-Propane sultone. In some embodiments, the formulation comprises about 0.1 wt %, about 0.25 wt %, about 0.5 wt %, about 0.75 wt %, about 1 wt %, about 1.5 wt %, about 2 wt %, about 2.5 wt %, or about 3 wt % 1,3-Propane sultone. In some embodiments, the formulation comprises at least about 0.1 wt %, about 0.25 wt %, about 0.5 wt %, about 0.75 wt %, about 1 wt %, about 1.5 wt %, about 2 wt %, about 2.5 wt %, or about 3 wt % 1,3-Propane sultone. In some embodiments, the formulation comprises at most about 0.25 wt %, about 0.5 wt %, about 0.75 wt %, about 1 wt %, about 1.5 wt %, about 2 wt %, about 2.5 wt %, or about 3 wt % 1,3-Propane sultone.

### Nonflammable Material

In some embodiments, the formulation comprises a nonflammable material. In some embodiments, the nonflammable material is an organophosphorous compounds. In some embodiments, the nonflammable material is ethoxy(pentafluoro)cyclotriphosphazene.

In some embodiments, the formulation comprises about 4 wt % to about 30 wt % of the nonflammable material by total electrolyte weight. In some embodiments, the formulation comprises about 4 wt % to about 10 wt % of the nonflammable material by total electrolyte weight. In some embodiments, the formulation comprises about 4 wt % to about 5 wt % of the nonflammable material by total electrolyte weight. In some embodiments, the formulation comprises at least about 5 wt % of the nonflammable material by total electrolyte weight.

In some embodiments, the formulation comprises about 4 wt % to about 40 wt % of the nonflammable material by total electrolyte weight. In some embodiments, the formulation comprises about 4 wt % to about 5 wt %, about 4 wt % to about 10 wt %, about 4 wt % to about 15 wt %, about 4 wt % to about 20 wt %, about 4 wt % to about 25 wt %, about 4 wt % to about 30 wt %, about 4 wt % to about 35 wt %, about 4 wt % to about 40 wt %, about 5 wt % to about 10 wt %, about 5 wt % to about 15 wt %, about 5 wt % to about 20 wt %, about 5 wt % to about 25 wt %, about 5 wt % to about 30 wt %, about 5 wt % to about 35 wt %, about 5 wt % to about 40 wt %, about 10 wt % to about 15 wt %, about 10 wt % to about 20 wt %, about 10 wt % to about 25 wt %, about 10 wt % to about 30 wt %, about 10 wt % to about 35 wt %, about 10 wt % to about 40 wt %, about 15 wt % to about 20 wt %, about 15 wt % to about 25 wt %, about 15 wt % to about 30 wt %, about 15 wt % to about 35 wt %, about 15 wt % to about 40 wt %, about 20 wt % to about 25 wt %, about 20 wt % to about 30 wt %, about 20 wt % to about 35 wt %, about 20 wt % to about 40 wt %, about 25 wt % to about 30 wt %, about 25 wt % to about 35 wt %, about 25 wt % to about 40 wt %, about 30 wt % to about 35 wt %, about 30 wt % to about 40 wt %, or about 35 wt % to about 40 wt % of the nonflammable material by total electrolyte weight. In some embodiments, the formulation comprises about 4 wt %, about 5 wt %, about 10 wt %, about 15 wt %, about 20 wt %, about 25 wt %, about 30 wt %, about 35 wt %, or about 40 wt % of the nonflammable material by total electrolyte weight. In some embodiments, the formulation comprises at least about 4 wt %, about 5 wt %, about 10 wt %, about 15 wt %, about 20 wt %, about 25 wt %, about 30 wt %, or about 35 wt % of the nonflammable material by total electrolyte weight. In some embodiments, the formulation comprises at most about 5 wt %, about 10 wt %, about 15 wt %, about 20 wt %, about 25 wt %, about 30 wt %, about 35 wt %, or about 40 wt % of the nonflammable material by total electrolyte weight.

In some embodiments, the nonflammable material scavenges H and OH radicals.

### Technical Effects

In some embodiments, the lithium salt and nonflammable material interact to mitigate decomposition of the lithium salt. In some embodiments, the one or more lithium salts and nonflammable material interact to mitigate decomposition of the one or more lithium salts. In some embodiments, the binary lithium salt system and nonflammable material interact to mitigate decomposition of the binary lithium salt system.

In some embodiments, the formulation remains clear and colorless for at least 12 days at 60 °C. In some embodiments, the formulation remains clear and colorless for about 5 days to about 40 days at 60 °C. In some embodiments, the formulation remains clear and colorless for about 5 days to about 10 days, about 5 days to about 12 days, about 5 days to about 15 days, about 5 days to about 20 days, about 5 days to about 25 days, about 5 days to about 30 days, about 5 days to about 35 days, about 5 days to about 40 days, about 10 days to about 12 days, about 10 days to about 15 days, about 10 days to about 20 days, about 10 days to about 25 days, about 10 days to about 30 days, about 10 days to about 35 days, about 10 days to about 40 days, about 12 days to about 15 days, about 12 days to about 20 days, about 12 days to about 25 days, about 12 days to about 30 days, about 12 days to about 35 days, about 12 days to about 40 days, about 15 days to about 20 days, about 15 days to about 25 days, about 15 days to about 30 days, about 15 days to about 35 days, about 15 days to about 40 days, about 20 days to about 25 days, about 20 days to about 30 days, about 20 days to about 35 days, about 20 days to about 40 days, about 25 days to about 30 days, about 25 days to about 35 days, about 25 days to about 40 days, about 30 days to about 35 days, about 30 days to about 40 days, or about 35 days to about 40 days at 60 °C. In some embodiments, the formulation remains clear and colorless for about 5 days, about 10 days, about 12 days, about 15 days, about 20 days, about 25 days, about 30 days, about 35 days, or about 40 days at 60 °C. In some embodiments, the formulation remains clear and colorless for at least about 5 days, about 10 days, about 12 days, about 15 days, about 20 days, about 25 days, about 30 days, about 35 days or about 40 days at 60 °C. In some embodiments, the formulation remains clear and colorless for at most about 10 days, about 12 days, about 15 days, about 20 days, about 25 days, about 30 days, about 35 days, or about 40 days at 60 °C.

In some embodiments, the formulation does not form LiPF₆ decomposition products for at least 12 days at 60 °C. In some embodiments, the formulation does not form LiPF₆ decomposition products for about 5 days to about 40 days at 60 °C. In some embodiments, the formulation does not form LiPF₆ decomposition products for about 5 days to about 10 days, about 5 days to about 12 days, about 5 days to about 15 days, about 5 days to about 20 days, about 5 days to about 25 days, about 5 days to about 30 days, about 5 days to about 35 days, about 5 days to about 40 days, about 10 days to about 12 days, about 10 days to about 15 days, about 10 days to about 20 days, about 10 days to about 25 days, about 10 days to about 30 days, about 10 days to about 35 days, about 10 days to about 40 days, about 12 days to about 15 days, about 12 days to about 20 days, about 12 days to about 25 days, about 12 days to about 30 days, about 12 days to about 35 days, about 12 days to about 40 days, about 15 days to about 20 days, about 15 days to about 25 days, about 15 days to about 30 days, about 15 days to about 35 days, about 15 days to about 40 days, about 20 days to about 25 days, about 20 days to about 30 days, about 20 days to about 35 days, about 20 days to about 40 days, about 25 days to about 30 days, about 25 days to about 35 days, about 25 days to about 40 days, about 30 days to about 35 days, about 30 days to about 40 days, or about 35 days to about 40 days at 60 °C. In some embodiments, the formulation does not form LiPF₆ decomposition products for about 5 days, about 10 days, about 12 days, about 15 days, about 20 days, about 25 days, about 30 days, about 35 days, or about 40 days at 60 °C. In some embodiments, the formulation does not form LiPF₆ decomposition products for at least about 5 days, about 10 days, about 12 days, about 15 days, about 20 days, about 25 days, about 30 days, or about 35 days at 60 °C. In some embodiments, the formulation does not form LiPF₆ decomposition products for at most about 10 days, about 12 days, about 15 days, about 20 days, about 25 days, about 30 days, about 35 days, or about 40 days at 60 °C.

In some embodiments, the formulation has an ionic conductivity of 5.8 mS/cm at room temperature. In some embodiments, the formulation has an ionic conductivity of up to about 5.8 mS/cm at room temperature. In some embodiments, the formulation has an ionic conductivity of at least about 5.5 mS/cm, 5.6 mS/cm, 5.7 mS/cm, 5.8 mS/cm, 5.9 mS/cm, or 6.0 mS/cm at room temperature.

In some embodiments, the formulation does not ignite upon exposure to fire for at least 10 seconds. In some embodiments, the formulation does not ignite upon exposure to fire for about 5 seconds to about 40 seconds. In some embodiments, the formulation does not ignite upon exposure to fire for about 5 seconds to about 10 seconds, about 5 seconds to about 12 seconds, about 5 seconds to about 15 seconds, about 5 seconds to about 20 seconds, about 5 seconds to about 25 seconds, about 5 seconds to about 30 seconds, about 5 seconds to about 35 seconds, about 5 seconds to about 40 seconds, about 10 seconds to about 12 seconds, about 10 seconds to about 15 seconds, about 10 seconds to about 20 seconds, about 10 seconds to about 25 seconds, about 10 seconds to about 30 seconds, about 10 seconds to about 35 seconds, about 10 seconds to about 40 seconds, about 12 seconds to about 15 seconds, about 12 seconds to about 20 seconds, about 12 seconds to about 25 seconds, about 12 seconds to about 30 seconds, about 12 seconds to about 35 seconds, about 12 seconds to about 40 seconds, about 15 seconds to about 20 seconds, about 15 seconds to about 25 seconds, about 15 seconds to about 30 seconds, about 15 seconds to about 35 seconds, about 15 seconds to about 40 seconds, about 20 seconds to about 25 seconds, about 20 seconds to about 30 seconds, about 20 seconds to about 35 seconds, about 20 seconds to about 40 seconds, about 25 seconds to about 30 seconds, about 25 seconds to about 35 seconds, about 25 seconds to about 40 seconds, about 30 seconds to about 35 seconds, about 30 seconds to about 40 seconds, or about 35 seconds to about 40 seconds. In some embodiments, the formulation does not ignite upon exposure to fire for about 5 seconds, about 10 seconds, about 12 seconds, about 15 seconds, about 20 seconds, about 25 seconds, about 30 seconds, about 35 seconds, or about 40 seconds. In some embodiments, the formulation does not ignite upon exposure to fire for at least about 5 seconds, about 10 seconds, about 12 seconds, about 15 seconds, about 20 seconds, about 25 seconds, about 30 seconds, or about 35 seconds. In some embodiments, the formulation does not ignite upon exposure to fire for at most about 10 seconds, about 12 seconds, about 15 seconds, about 20 seconds, about 25 seconds, about 30 seconds, about 35 seconds, or about 40 seconds.

In some embodiments, the formulation is stable with sulfur compounds for at least 12 days at 60 °C. In some embodiments, the formulation is stable with sulfur compounds for about 5 days to about 40 days at 60 °C. In some embodiments, the formulation is stable with sulfur compounds for about 5 days to about 10 days, about 5 days to about 12 days, about 5 days to about 15 days, about 5 days to about 20 days, about 5 days to about 25 days, about 5 days to about 30 days, about 5 days to about 35 days, about 5 days to about 40 days, about 10 days to about 12 days, about 10 days to about 15 days, about 10 days to about 20 days, about 10 days to about 25 days, about 10 days to about 30 days, about 10 days to about 35 days, about 10 days to about 40 days, about 12 days to about 15 days, about 12 days to about 20 days, about 12 days to about 25 days, about 12 days to about 30 days, about 12 days to about 35 days, about 12 days to about 40 days, about 15 days to about 20 days, about 15 days to about 25 days, about 15 days to about 30 days, about 15 days to about 35 days, about 15 days to about 40 days, about 20 days to about 25 days, about 20 days to about 30 days, about 20 days to about 35 days, about 20 days to about 40 days, about 25 days to about 30 days, about 25 days to about 35 days, about 25 days to about 40 days, about 30 days to about 35 days, about 30 days to about 40 days, or about 35 days to about 40 days at 60 °C. In some embodiments, the formulation is stable with sulfur compounds for about 5 days, about 10 days, about 12 days, about 15 days, about 20 days, about 25 days, about 30 days, about 35 days, or about 40 days at 60 °C. In some embodiments, the formulation is stable with sulfur compounds for at least about 5 days, about 10 days, about 12 days, about 15 days, about 20 days, about 25 days, about 30 days, about 35 days or about 40 days at 60 °C. In some embodiments, the formulation is stable with sulfur compounds for at most about 10 days, about 12 days, about 15 days, about 20 days, about 25 days, about 30 days, about 35 days, or about 40 days at 60 °C.

In some embodiments, the formulation does not produce gas products when heated to 60 °C. In some embodiments, the formulation does not produce gas products when heated to 62 °C. In some embodiments, the formulation does not produce gas products when heated to 65 °C. In some embodiments, the formulation does not produce gas products when heated to 67 °C. In some embodiments, the formulation does not produce gas products when heated to 70 °C.

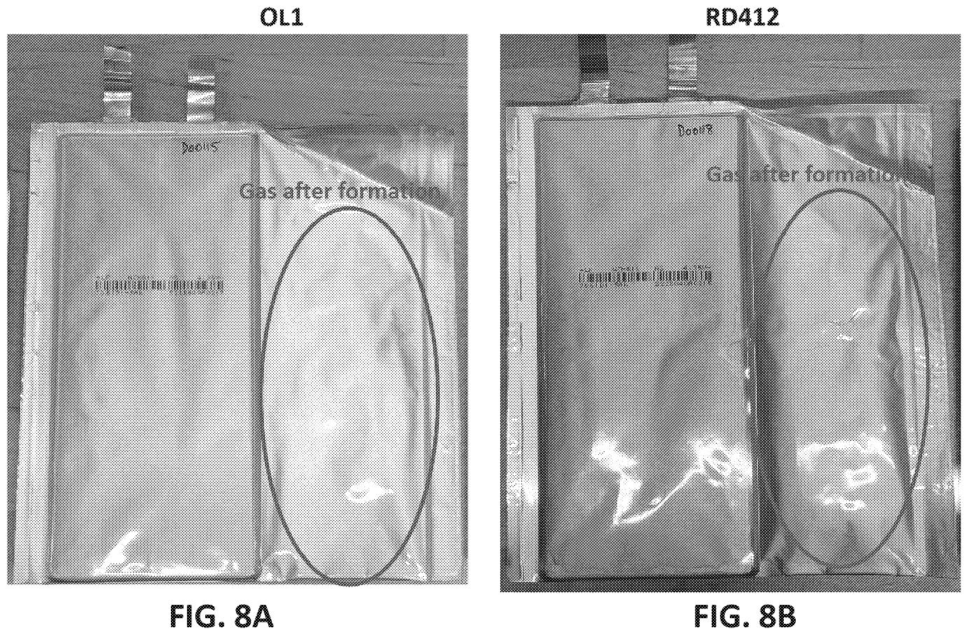

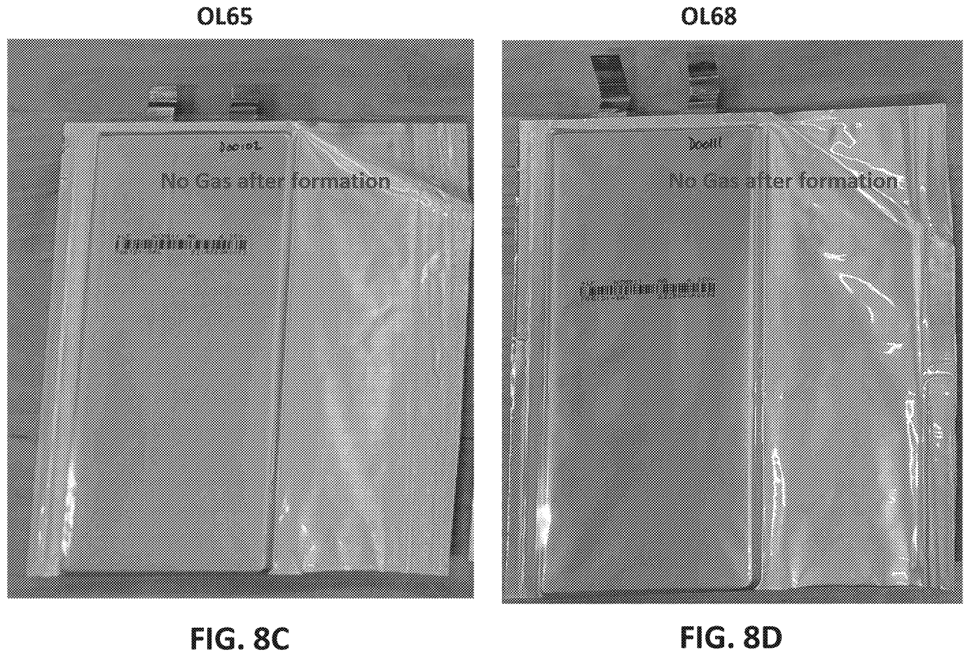

In some embodiments, the formulation does not produce gas products leading to cell bulging. FIGS. 8A-8B show gas formation using devices with OL1 and RD412 formulations. FIGS. 8C-8D do not show gas formation using devices with OL65 and OL68, owing to lack of undesired reactions on the surface of the anode as well as the production of a good solid electrolyte interphase layer.

### Uses

In an aspect of the present disclosure is use of a non-flammable electrolyte formulation disclosed herein in a method of preventing thermal runaway, comprising providing a formulation comprising one or more non-aqueous organic solvents, a cathode additive, one or more anode additives, and a non-flammable material comprising phosphazene in an amount greater than 5% up to 25% w/w of the formulation, and operating an energy storage device comprising the formulation under conditions which heat the formulation, wherein the formulation is self-extinguishing or does not exhibit a decrease in output voltage greater than 10% of an initial output voltage in a cell comprising the electrolyte when heated to a temperature of at least 60 °C.

### Lithium Ion Energy Storage Device

In an aspect of the present disclosure is a lithium ion energy storage device comprising: a positive electrode including a nickel-cobalt-manganese positive electrode active material, an anode electrode, a separator interposed between the positive electrode and the negative electrode, and the nonflammable electrolyte formulation as disclosed herein.

In an aspect of the present disclosure is a lithium ion energy storage device comprising an anode electrode, a cathode electrode, and an electrolyte formulation comprising one or more non-aqueous organic solvents, a cathode additive, one or more anode additives, a binary lithium salt system, and a non-flammable material comprising ethoxy(pentafluoro)cyclotriphosphazene, wherein the energy storage device does not exhibit a decrease in output voltage greater than 10% of an initial output voltage when heated to a temperature of at least 60 °C.

In some embodiments, the positive electrode active material is Li(NiaCobMnc)O2, which is 0.6<a<0.95, 0.025<b<0.20, 0.025<c<0.20, and a+b+c=1 in lithium secondary battery.

In some embodiments, the anode electrode comprises natural graphite, artificial graphite, a combination of natural and artificial graphite, or mesocarbon microbeads (MCMB). In some embodiments, the anode comprises graphite, carbon black, a hydrophilic binder, carboxymethyl cellulose, or any combination thereof. In some embodiments, the hydrophilic binder comprises styrene butadiene (SBR), polyvinylidene fluoride (PVDF), sodium alginate, polytetrafluoroethylene (PTFE), sodium carboxymethyl chitosan (CCTS), polyacrylic acid (PAA), polystyrene sulfonate (PSS), polyvinyl alcohol (PVA), poly(fluorene), polyphenylene, polypyrene, polyazulene, polynaphthalene, poly(acetylene), poly(p-phenylene vinylene), poly(pyrrole) (PPY), poly carbazole, polyindole, polyazepine, poly(thiophene)s (PT), poly(3,4-ethylenedi oxy thiophene) (PEDOT), poly(p-phenylene sulfide) (PPS), polyaniline (PANI), or any combination thereof.

In some embodiments, the cathode electrode comprises cobalt nickel-manganese-cobalt (NCM). In some embodiments, the cathode comprises a Ni content of greater than 80% wt. In some embodiments, the cathode comprises cobalt. In some embodiments, the cathode is a lithium nickel cobalt aluminum oxide (NCA) cathode. In some embodiments, the cathode is a nickel:cobalt:manganese (NMC) cathode. In some embodiments, the cathode comprises lithium cobalt oxide. In some embodiments, the cathode comprises polyvinylidine fluoride (PVDF), carbon black, graphene, or any combination thereof. In some embodiments, the polyvinylidine fluoride (PVDF) is in an N-methyl-2-pyrrolidone solvent. In some embodiments, the graphene comprises a reduced graphene oxide dispersion.

In some embodiments, the energy storage device has at least 90% capacity retention at 500 cycles. In some embodiments, the energy storage device has at least 91% capacity retention at 500 cycles. In some embodiments, the energy storage device has at least 92% capacity retention at 500 cycles. In some embodiments, the energy storage device has at least 93% capacity retention at 500 cycles. In some embodiments, the energy storage device has at least 94% capacity retention at 500 cycles. In some embodiments, the energy storage device has at least 95% capacity retention at 500 cycles.

In some embodiments, the energy storage device has at least 85% capacity retention at 500 cycles at 4.3 V. In some embodiments, the energy storage device has at least 86% capacity retention at 500 cycles at 4.3 V. In some embodiments, the energy storage device has at least 87% capacity retention at 500 cycles at 4.3 V. In some embodiments, the energy storage device has at least 88% capacity retention at 500 cycles at 4.3 V. In some embodiments, the energy storage device has at least 89% capacity retention at 500 cycles at 4.3 V. In some embodiments, the energy storage device has at least 90% capacity retention at 500 cycles at 4.3 V. In some embodiments, the energy storage device has at least 91% capacity retention at 500 cycles at 4.3 V. In some embodiments, the energy storage device has at least 92% capacity retention at 500 cycles at 4.3 V. In some embodiments, the energy storage device has at least 93% capacity retention at 500 cycles at 4.3 V. In some embodiments, the energy storage device has at least 94% capacity retention at 500 cycles at 4.3 V. In some embodiments, the energy storage device has at least 95% capacity retention at 500 cycles at 4.3 V.

In some embodiments, the energy storage device loses at most 15% capacity retention by 500 cycles at 4.3 V. In some embodiments, the energy storage device loses at most 12% capacity retention by 500 cycles at 4.3 V. In some embodiments, the energy storage device loses at most 11% capacity retention by 500 cycles at 4.3 V. In some embodiments, the energy storage device loses at most 10% capacity retention by 500 cycles at 4.3 V. In some embodiments, the energy storage device loses at most 9% capacity retention by 500 cycles at 4.3 V. In some embodiments, the energy storage device loses at most 8% capacity retention by 500 cycles at 4.3 V. In some embodiments, the energy storage device loses at most 7% capacity retention by 500 cycles at 4.3 V.

In some embodiments, the energy storage device has a coulombic efficiency of at least 88%. In some embodiments, the energy storage device has a coulombic efficiency of at least 89%, at least 89.5%, at least 89.7%, or at least 90%. In some embodiments, the energy storage device does not exhibit a decrease in output voltage greater than 10% of an initial output voltage when stored at a temperature of at least 60 °C for up to 10 weeks.

In some embodiments, the energy storage device has a charge density of at least 5.0 Ah. In some embodiments, the energy storage device has a charge density of about 4.9 Ah, about 5 Ah, about 5.01 Ah, about 5.02 Ah, about 5.03 Ah, or about 5.04 Ah. In some embodiments, the energy storage device has a charge density of at least about 4.9 Ah, about 5 Ah, about 5.01 Ah, about 5.02 Ah, or about 5.03 Ah. In some embodiments, the energy storage device has a charge density of at most about 5 Ah, about 5.01 Ah, about 5.02 Ah, about 5.03 Ah, or about 5.04 Ah.

In some embodiments, the energy storage device is a battery. In some embodiments, the energy storage device is a capacitor.

In some embodiments, the energy storage device comprising the formulation maintains at least 87% capacity retention at 500 cycles at 4.3V. In some embodiments, the energy storage device comprising the formulation maintains at least 86% capacity retention at 500 cycles at 4.3V. In some embodiments, the energy storage device comprising the formulation maintains at least 88% capacity retention at 500 cycles at 4.3V. In some embodiments, the energy storage device comprising the formulation maintains at least 80% capacity retention at 1000 cycles at 4.3V.

In some embodiments, the formulation does not increase resistance of overall battery cell. In some embodiments, the formulation does not increase resistance of overall battery cell when heated to 60 °C.

### EXAMPLES

### Example 1—Electrolyte Formulation Preparation

The novel nonflammable non-aqueous electrolytes OL63 and 64 are formulations in which LiPF₆ is dissolved in a mixed solvent of Ethylene Carbonate (EC), Diethyl Carbonate (DEC) and Ethyl Methyl Carbonate (EMC) in a weight ratio of 30:30:40 so as to be 1.15M solution. Additives claimed in the present disclosure are further added.

The Ethoxy(pentafluoro)cyclotriphosphazene is added more preferably in 6% to 20% by weight based on the total weight of the electrolyte.

The Adiponitrile (ADN) is added more preferably in 1 to 3% by weight based on the total weight of the electrolyte.

The Lithium Bis(oxalato)borate (LiBOB) is added more preferably in 1 to 3% by weight based on the total weight of the electrolyte.

The Vinylene Carbonate (VC) is added more preferably in 1 to 3% by weight based on the total weight of the electrolyte.

1,3-Propane Sultone (PS) is included more preferably in 0.5% to 2% by weight based on the total weight of the electrolyte.

The electrolyte OL1 was prepared in similar method to OL63 and 64. The electrolyte OL1 includes a lithium salt LiBF₄ in concentration of 1.00M. The formulation contains Gamma-Butyrolactone (GBL) and 1,1,2,2-Tetrafluoroethyl-2,2,3,3-Tetrafluoropropyl Ether (HFE-458) in the ratio of GBL/HFE-458 (70/30 by weight). The electrolyte includes additives, Lithium Bis(oxalate)borate (LiBOB) in 2.5% by weight and Vinylene Carbonate (VC) in 2.5% by weight.

The nonflammable non-aqueous electrolytes OL66 and 67 were prepared by further adding Ethoxy(pentafluoro)cyclotriphosphazene into OL1, in 10% and 20% by weight based on the total weight of the electrolyte.

The non-aqueous RD412 is prepared by dissolving LiPF₆ in a mixed solvent of Ethylene Carbonate (EC), Propylene Carbonate (PC) and Diethyl Carbonate (DEC) in a weight ratio of 25:5:70 so as to be 1.00M solution. Then, additives are further added shown in the table above, Vinylene Carbonate (VC) in 1% by weight and 1,3-Propane Sultone (PS) 1% by weight.

Further electrolyte formulations can be found in Table 1. RD412 is a commercial formulation and OL1 is a comparative formulation.

TABLE 1
Electrolyte Formulations

| | Solvent (w/w) | | | | | | Salt (M) | | Additives (wt %) | | | | |
|---|---|---|---|---|---|---|---|---|---|---|---|---|---|
| Electrolyte | EC | PC | DEC | EMC | GBL | FEP | LiPF₆ | LiBF₄ | ADN | LiBOB | VC | PS | P2 |
| OL1 | | | | | 7 | 3 | | 1.00 | | 2.5 | 2.5 | | |
| RD412 | 2.5 | 0.5 | 7 | | | | 1.00 | | | | 1.0 | 1.0 | |
| OL63 | 3 | | 3 | 4 | | | 1.15 | | 1 | 2.5 | 1.5 | 1.0 | 10 |
| OL64 | 3 | | 3 | 4 | | | 1.15 | | 1 | 2.5 | 1.5 | 1.0 | 20 |
| OL66 | | | | | 7 | 3 | | 1.00 | | 2.5 | 2.5 | | 10 |
| OL67 | | | | | 7 | 3 | | 1.00 | | 2.5 | 2.5 | | 20 |

### Example 2—Lithium Ion Energy Storage Device Fabrication

Lithium secondary batteries implemented in accordance with embodiments of this invention include a cathode, anode, and separator disposed between the two electrodes in order to prevent a short circuit. Then, electrolyte is injected into the cell. The lithium secondary batteries of the present invention are produced in a form of pouch type, but not limited to the single type. In addition to the pouch type, cylindrical, prismatic or polymer pouch cells can be produced.

Ni-rich NCM, LiNi_{0.8}Co_{0.1}Mn_{0.1}O₇ is used as a positive electrode active material, and polyvinylidene fluoride (PVDF) is used as a binder and super-p as a conductive agent. A slurry of positive electrode active material was prepared by mixing and dispersing a positive electrode active material, binder and conductive agent in a specific weight ratio in N-methyl-2-pyrrolidone (NMP). The slurry was coated on an aluminum foil having a thickness of 12 μm, dried, and rolled to prepare a positive electrode. Synthetic graphite is dispersed with styrene-butadiene rubber (SBR) as a binder and carboxymethyl cellulose (CMC) as a thickener in a specific weight ratio in water to prepare a slurry of negative electrode active material. The slurry was coated on a copper foil having a thickness of 8 μm, dried, and rolled to prepare a negative electrode. A 20 μm thick polyethylene (PE) or polypropylene separator was winded with cathode and anode to form cells of 5 Ah. Lithium ion secondary batteries are finally manufactured by injecting a non-aqueous electrolyte.

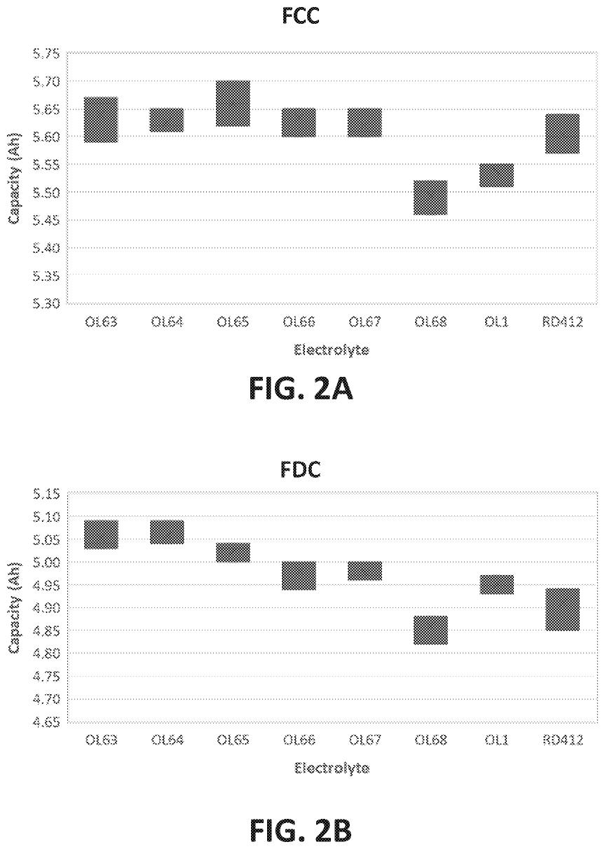

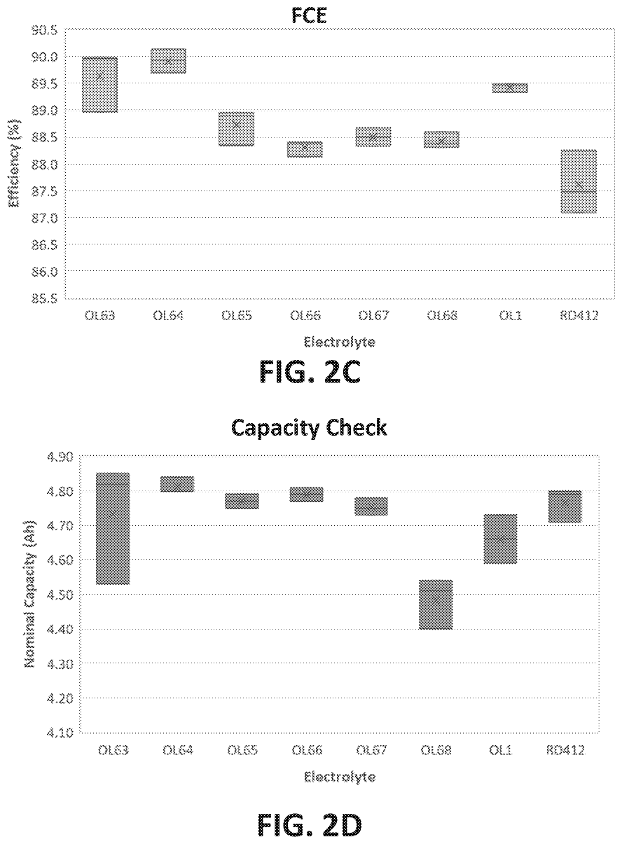

FIG. 2A displays the full charge capacity of devices comprising one of OL63, OL64, OL65, OL66, OL67, OL68, OL1, and RD412. The specific values are listed in Table 2.

FIG. 2B displays the full discharge capacity of devices comprising one of OL63, OL64, OL65, OL66, OL67, OL68, OL1, and RD412. Formulations OL63 and OL64 show a higher capacity of approximately 5.05 Ah compared to the other formulations, including commercial formulation RD412 and comparative formulation OL1. The specific values are listed in Table 2.

FIG. 2C displays the first cycle efficiency of devices comprising one of OL63, OL64, OL65, OL66, OL67, OL68, OL1, and RD412. Formulations OL63 and OL64 show a higher efficiency of approximately 89% compared to the other formulations, including commercial formulation RD412. The specific values are listed in Table 2.

TABLE 2
5Ah Cell Formation Data.

| | | | 1st | | | | Nom C | | |
|---|---|---|---|---|---|---|---|---|---|
| | | PreC | Charge | FCC | FCD | FCE | (Ah) | Nom E | Nom V |
| Device | Electrolyte | (Ah) | (Ah) | (Ah) | (Ah) | (%) | @C/3 | (Wh) | (V) |
| D0096 | OL63 | 1.0000 | 4.593 | 5.593 | 5.031 | 90.0 | 4.8152 | 17.5415 | 3.6244 |
| D0097 | OL63 | 1.0003 | 4.665 | 5.666 | 5.041 | 89.0 | 4.8480 | 17.6701 | 3.6272 |
| D0098 | OL63 | 1.0003 | 4.658 | 5.658 | 5.091 | 90.0 | 4.5277 | 16.4632 | 3.6171 |
| D0099 | OL64 | 1.0002 | 4.645 | 5.645 | 5.089 | 90.1 | 4.8437 | 17.6301 | 3.6209 |
| D0100 | OL64 | 1.0004 | 4.606 | 5.606 | 5.042 | 89.9 | 4.7985 | 17.4633 | 3.6218 |
| D0101 | OL64 | 1.0003 | 4.615 | 5.615 | 5.037 | 89.7 | 4.8029 | 17.4853 | 3.6235 |
| D0105 | OL66 | 1.0002 | 4.652 | 5.652 | 4.997 | 88.4 | 4.8120 | 17.5026 | 3.6194 |
| D0106 | OL66 | 1.0002 | 4.602 | 5.602 | 4.937 | 88.1 | 4.7698 | 17.3629 | 3.6238 |
| D0107 | OL66 | 1.0002 | 4.654 | 5.655 | 4.998 | 88.4 | 4.7905 | 17.4291 | 3.6210 |
| D0108 | OL67 | 1.0003 | 4.603 | 5.603 | 4.968 | 88.7 | 4.7289 | 17.1866 | 3.6179 |
| D0109 | OL67 | 1.0003 | 4.614 | 5.615 | 4.960 | 88.3 | 4.7499 | 17.2727 | 3.6198 |
| D0110 | OL67 | 1.0004 | 4.647 | 5.647 | 4.997 | 88.5 | 4.7797 | 17.3692 | 3.6180 |
| D0114 | OL1 | 1.0004 | 4.545 | 5.545 | 4.953 | 89.3 | 4.7342 | 17.2106 | 3.6194 |
| D0115 | OL1 | 1.0004 | 4.510 | 5.510 | 4.929 | 89.4 | 4.5918 | 16.6547 | 3.6087 |
| D0116 | OL1 | 1.0004 | 4.553 | 5.553 | 4.970 | 89.5 | Leaking | | |
| D0117 | RD412 | 1.0004 | 4.597 | 5.597 | 4.940 | 88.3 | 4.7975 | 17.5404 | 3.6399 |
| D0118 | RD412 | 1.0000 | 4.642 | 5.642 | 4.936 | 87.5 | 4.7867 | 17.4956 | 3.6377 |
| D0119 | RD412 | 1.0003 | 4.568 | 5.568 | 4.850 | 87.1 | 4.7075 | 17.2313 | 3.6465 |

FIG. 2D displays the nominal capacity of devices comprising one of OL63, OL64, OL65, OL66, OL67, OL68, OL1, and RD412. The specific values are listed in Table 2.

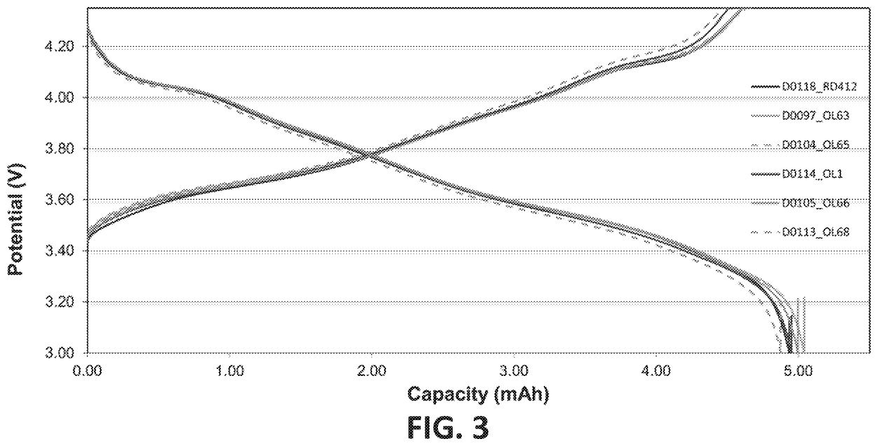

Formation: Charge and discharge cycle were performed at 0.1 C rate, then another cycle at 0.2 C rate. The first cycle efficiency was calculated at 0.1 C. The formation voltage profile is depicted in FIG. 3 and measured at voltages from 3.0 V to 4.35 V. Formulations OL63, OL65, OL66, and OL68 show very similar voltage profiles as commercial formulation RD412 and comparative formulation OL1, indicating that there is no overpotential causing resistance.

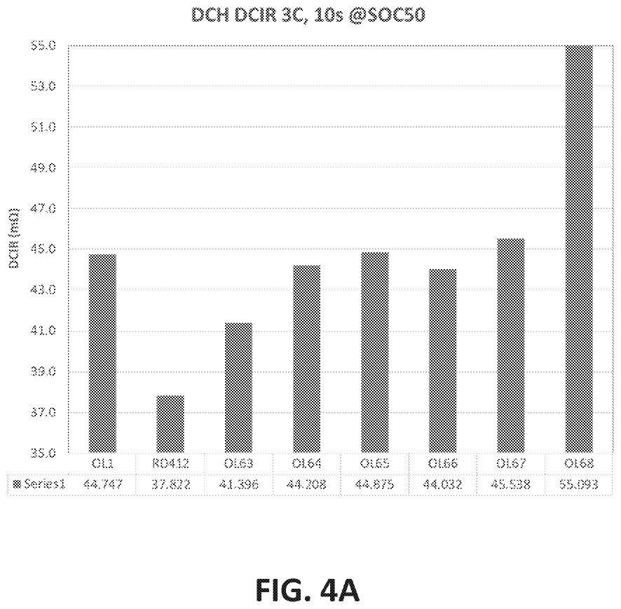

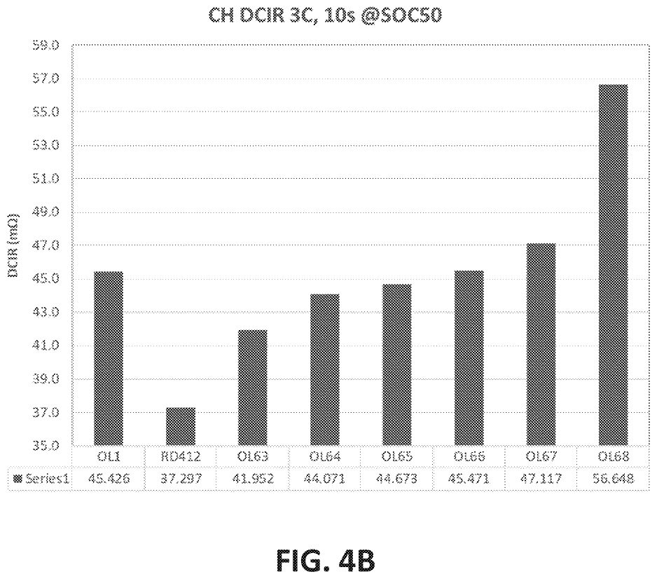

Charge and discharge of devices comprising one of OL63, OL64, OL65, OL66, OL67, OL68, OL1, and RD412 were measured at 3 Coulombs for 10 seconds at 50% state of charge as depicted in FIGS. 4A-4B. Formulations OL63, OL64, OL65, OL66, OL67 show comparable direct current internal resistance values to comparative formulation OL1.

Nominal capacity: Two cycles were performed at 0.3 C rate and the discharge capacity of second cycle was the measured nominal capacity.

Cycling test at room temperature: A process of CC-CV charging the cells at room temperature at 0.2 C rate (4.30V, 0.05 C cut-off) and CC discharging the cells at a current of 0.5 C rate up to 3.00V was repeated until the retention capacity reached 80% of the discharge capacity of the first cycle. Here, a capacity retention of the cycle life was calculated by dividing the discharge capacity by the discharge capacity at the first cycle.

Capacity retention of cell=(discharge capacity/initial capacity)×100(%)

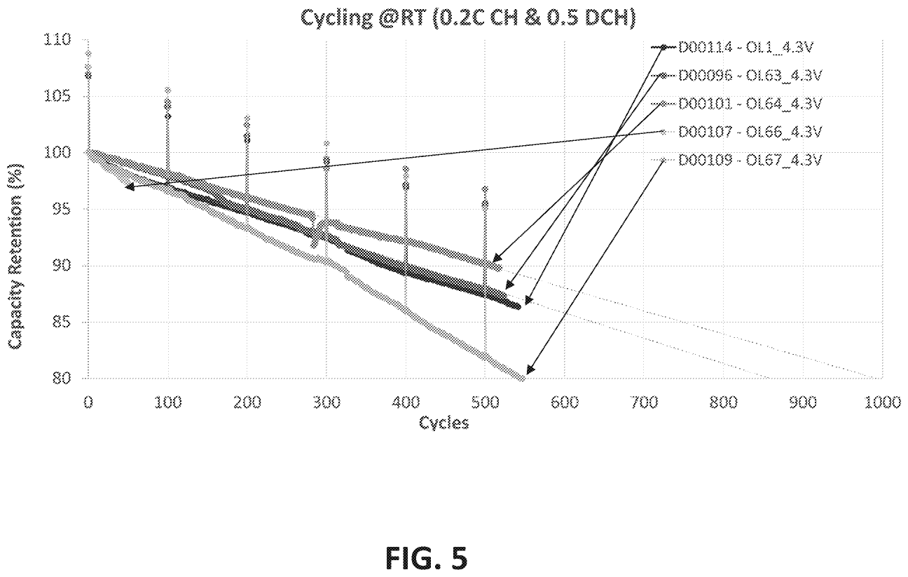

FIG. 5 shows the cycle test using formulations OL1, OL63, OL64, OL66, and OL67. OL64 has a superior capacity retention of approximately 90% retention at 500 cycles. Electrolyte formulations disclosed herein are projected to have 1000 cycles to end of life.

High temperature storage test: the cell was charged in CC CV (4.20V, 0.05 C cut-off) at 0.2 C rate at room temperature, and stored at high temperatures in a 60 °C oven for 14 weeks. OCV/IR were measured every week.

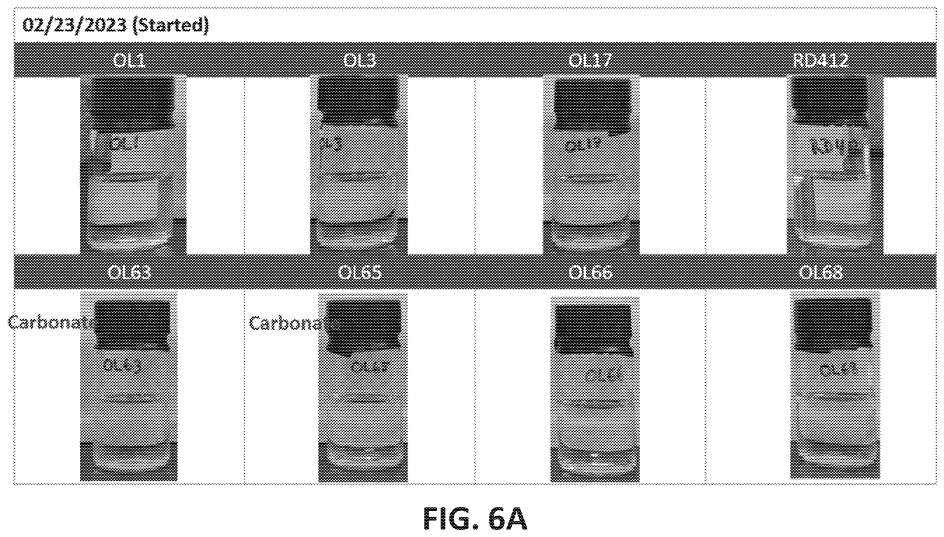

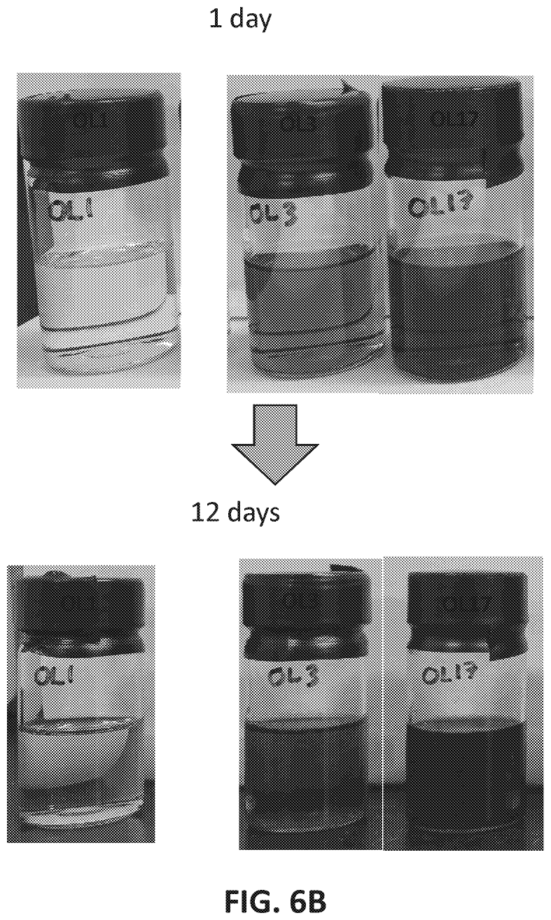

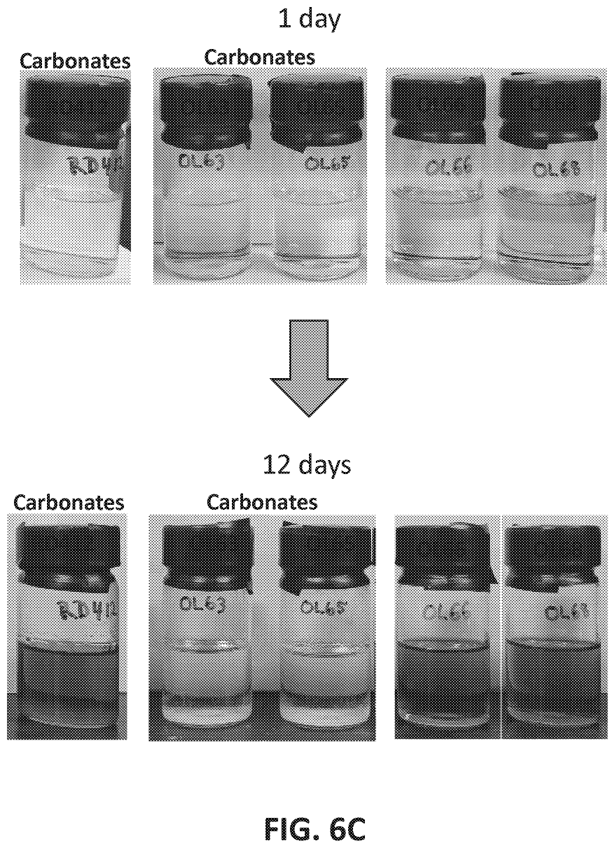

FIGS. 6A-6C depict a visual thermal stability test of formulations OL1, OL3, OL17, RD412, OL63, OL65, OL66 and OL68. At time of preparation, each formulation is clear and colorless (FIG. 6A). Following 1 day of storage at 60 °C, OL3 and OL17 are brown, owing to thermal degradation, and OL1 shows a faint yellow tint. At 12 days of storage at 60 °C, OL17 is nearly black, OL3 is a dark brown, and OL1 is tan, indicative of thermal degradation products (FIG. 6B). Following 1 day of storage at 60 °C, OL66 and OL68 are yellow, owing to thermal degradation, and RD412, OL63, and OL65 remain clear and colorless. At 12 days of storage at 60 °C, OL66, OL68, and RD412 are dark, indicative of thermal degradation products, while OL63 and OL65 remain clear and colorless (FIG. 6C).

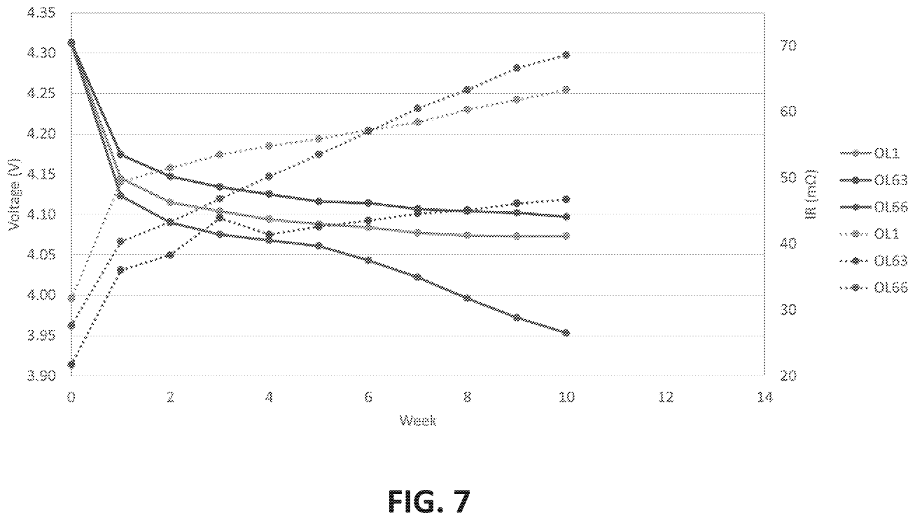

FIG. 7 shows the weekly OCV/IR measurements taken over the course of 10 weeks of OL1, OL63, and OL66. OL63 shows superior thermal stability than OL1 and OL66.

### Example 3—Flammability Test

The flammability test of electrolyte formulations disclosed herein was implemented. Electrolyte (e.g., 2 g) was placed into stainless steel cap of coin cells, then ignited by a flame using a gas torch and the flame was contacted with electrolyte until 10 seconds had passed. Once the flame was removed, it was determined if the electrolyte is flammable, self-extinguishing, and completely nonflammable.

### Example 4—Ionic Conductivity

Conductivity meter (e.g., Seven2Go Conductivity meter S3) and conductivity probe (e.g., InLab 738-ISM IP67) were used to measure ionic conductivity of electrolyte formulations disclosed herein. Electrolyte (e.g., 40 mL) was placed into a beaker and stirred with a magnetic stir bar. The conductivity meter was turned on and the sensor side of the probe was fully submerged into the electrolyte. Then, the meter displayed a measurement of conductivity and temperature.

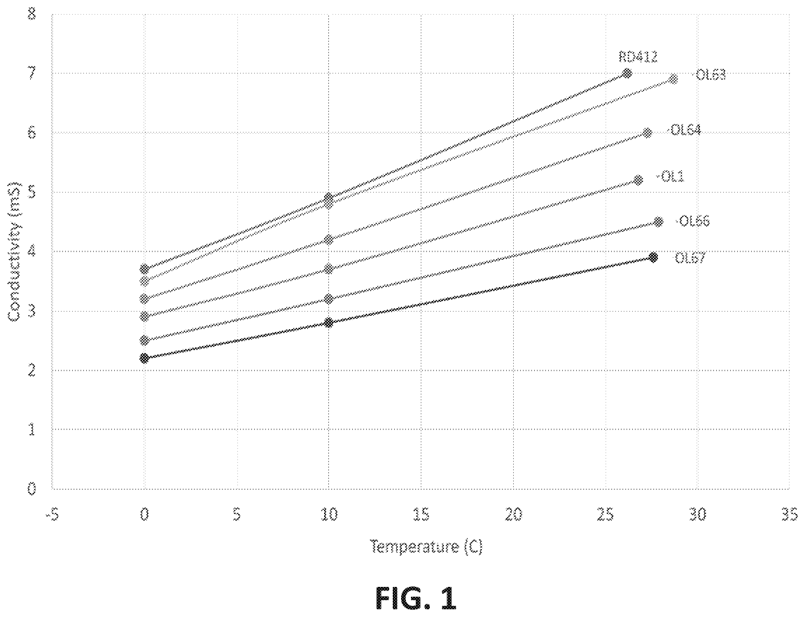

FIG. 1 shows the ionic conductivity of electrolyte formulations RD412, OL1, OL63, OL64, OL66, and OL67 at 0 °C, 10 °C, and room temperature. Compared to commercial formulation RD412, OL63 shows a nearly similar ionic conductivity of approximately 7 mS at room temperature. OL64 shows an ionic conductivity of approximately 6 mS at room temperature.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations or equivalents. It is intended that the following claims define the scope of the disclosure and that methods and structures within the scope of these claims and their equivalents be covered thereby.

1. A non-flammable electrolyte formulation comprising:
one or more non-aqueous organic solvents selected from the group consisting of ethylene carbonate (EC), propylene carbonate (PC), diethyl carbonate (DEC), dimethyl carbonate (DMC), ethyl methyl carbonate (EMC), gamma-butyrlactone (GBL), and 1, 1,2, 2-Tetrafluoroethyl-2, 2,3,3-tetrafluoropropyl ether (FEP);
a cathode additive selected from the group consisting of 1,3,6-hexanetricarbonitrile (HTCN), succinonitrile, and adiponitrile, the cathode additive is present at a concentration of 0.5-5% by weight;
one or more anode additives selected from the group consisting of lithium bis(oxalato)borate (LiBOB), vinylene carbonate (VC), and 1,3-propane sultone (PS);
one or more lithium salts selected from the group consisting of hexafluorophosphate (LiPF₆) and lithium tetrafluoroborate (LiBF₄); and
a non-flammable material having a concentration of 5-25% by weight,
wherein the non-flammable electrolyte formulation is self-extinguishing or does not combust when exposed to flame.

2. The non-flammable electrolyte formulation of claim 1, wherein the one or more non-aqueous solvents are selected from the group consisting of ethylene carbonate (EC), propylene carbonate (PC), and diethyl carbonate (DEC).

3. The non-flammable electrolyte formulation of claim 1, wherein the one or more non-aqueous solvents comprise each of ethylene carbonate (EC), propylene carbonate (PC), and diethyl carbonate (DEC).

4. The non-flammable electrolyte formulation of claim 1, wherein the one or more non-aqueous solvents comprises each of gamma-butyrlactone (GBL) and 1, 1,2, 2-tetrafluoroethyl-2, 2,3,3-tetrafluoropropyl ether (FEP).

5. The non-flammable electrolyte formulation of claim 4, wherein gamma-butyrlactone (GBL) is present at a higher amount by weight than tetrafluoroethyl-2, 2,3,3-tetrafluoropropyl ether (FEP).

6. The non-flammable electrolyte formulation of claim 1, wherein the cathode additive is selected from the group consisting of 1,3,6-hexanetricarbonitrile (HTCN), succinonitrile, and adiponitrile.

7. The non-flammable electrolyte formulation of claim 1, wherein the cathode additive comprises 1,3,6-hexanetricarbonitrile (HTCN).

8. The non-flammable electrolyte formulation of claim 1, wherein the cathode additive comprises succinonitrile.

9. The non-flammable electrolyte formulation of claim 1, wherein the cathode additive comprises adiponitrile.

10. The non-flammable electrolyte formulation of claim 9, wherein the adiponitrile has a concentration of 1-3 wt %.

11. The non-flammable electrolyte formulation of claim 1, wherein the one or more anode additives comprises both lithium bis(oxalato)borate (LiBOB) and vinylene carbonate (VC).

12. The non-flammable electrolyte formulation of claim 1, wherein the one or more anode additives comprises each of lithium bis(oxalato)borate (LiBOB), vinylene carbonate (VC), and 1,3-propane sultone (PS).

13. The non-flammable electrolyte formulation of claim 12, wherein each of LiBOB, VC, and PS is present at a concentration of at least 0.5 wt % by total electrolyte weight.

14. The non-flammable electrolyte formulation of claim 1, wherein:
the one or more anode additives comprises 1,3-propane sultone (PS), and
the 1,3-propane sultone (PS) is an only sulfur-containing compound in the non-flammable electrolyte formulation.

15. The non-flammable electrolyte formulation of claim 1, wherein the one or more lithium salts comprises lithium hexafluorophosphate (LiPF6) at a concentration of 0.8-1.6 M.

16. The non-flammable electrolyte formulation of claim 1, wherein the one or more lithium salts comprises lithium tetrafluoroborate (LiBF4) at a concentration of 0.8-1.6 M.

17. The non-flammable electrolyte formulation of claim 1, wherein the one or more lithium salts comprises both lithium hexafluorophosphate (LiPF6) and lithium tetrafluoroborate (LiBF4).

18. The non-flammable electrolyte formulation of claim 1, wherein the non-flammable material comprises ethoxy(pentafluoro)cyclotriphosphazene.

19. The non-flammable electrolyte formulation of claim 18, wherein the ethoxy(pentafluoro)cyclotriphosphazene has a concentration of 6-20 wt %.

20. The non-flammable electrolyte formulation of claim 1, wherein the non-flammable electrolyte formulation has an ionic conductivity of at least 5.5 mS/cm at room temperature.
